(19) United States
(12) Patent Application Publication
(10) Pub. No.: US 2026/0012975 A1
(43) Pub. Date: Jan. 8, 2026

(54) METHOD AND DEVICE FOR CONFIGURING CONDITION FOR PERFORMING VARIABLE NON-PRIMARY CHANNEL ACCESS IN WIRELESS LAN SYSTEM

(71) Applicant: SAMSUNG ELECTRONICS CO., LTD., Suwon-si (KR)

(72) Inventors: Jonghoe KOO, Suwon-si (KR); Seongho BYEON, Suwon-si (KR); Jinho CHOI, Suwon-si (KR); Suhwook KIM, Suwon-si (KR); Jungjun KIM, Suwon-si (KR)

(21) Appl. No.: 19/263,361

(22) Filed: Jul. 8, 2025

(30) Foreign Application Priority Data
Jul. 8, 2024 (KR) 10-2024-0089911

(51) Int. Cl. H04W 74/0808; H04L 1/00

(52) U.S. Cl. CPC H04W 74/0808; H04L 1/0003

(57) ABSTRACT

The disclosure relates to a wireless LAN system. An embodiment of the disclosure provides a method and a device for configuring an STA capable of performing NPCA so as to efficiently perform non-primary channel access (NPCA). The method of an electronic device comprises: obtaining a non-primary channel access (NPCA) information element; transmitting a frame including the NPCA information element; and performing an NPCA with a station (STA) associated with the electronic device on a non-primary channel (NPCH), wherein the NPCA information element comprises basic NPCA information and NPCA-enabling condition information.

### CROSS-REFERENCE TO RELATED APPLICATION

This application is based on and claims priority under 35 U.S.C. § 119 to Korean Patent Application No. 10-2024-0089911, filed on Jul. 8, 2024, in the Korean Intellectual Property Office, the disclosure of which is herein incorporated by reference in its entirety.

### BACKGROUND

### 1. Field

The disclosure relates to a method and a device for transmitting a signal in a wireless local area network (WLAN) system and, more specifically, to method and device for configuring a condition for performing non-primary channel access.

### 2. Description of Related Art

A wireless short-range communication network (wireless local area network, wireless LAN, WLAN) is also referred to as Wireless Fidelity (Wi-Fi), and is a network that enables users to utilize the Internet via mobile terminals or laptops within a certain distance from a location equipped with an access point (AP). WLAN technology has been continuously evolving with the popularization of Internet and the expansion of the smartphone market, and WLAN is utilized in providing high-speed data services across urban areas, including schools, airports, hotels, and offices.

The Wi-Fi alliance defines Wi-Fi as a WLAN product based on the Institute of Electrical and Electronics Engineers (IEEE) 802.11 standard. IEEE 802.11a and 802.11b, published in 1997 and 1999 respectively, are standards that use unlicensed bands in 2.4 GHz or 5 GHz. IEEE 802.11b provides a data rate of 11 Mbps, while IEEE 802.11a provides 54 Mbps. IEEE 802.11g applies orthogonal frequency-division multiplexing (OFDM) at 2.4 GHz to provide a data rate of 54 Mbps. IEEE 802.11n applies multiple input multiple output OFDM (MIMO-OFDM) to provide a data rate of 300 Mbps by using four spatial streams. In addition, IEEE 802.11n supports a channel bandwidth of up to 40 MHz, and provides a data rate of 600 Mbps.

Subsequently, the IEEE 802.11ac standard using up to 160 MHz bandwidth and supporting eight spatial streams to achieve speeds of up to 1 Gbps, and IEEE 802.11ax providing multi-user MIMO (MU-MIMO) in uplink and downlink, and supporting spatial frequency reuse and dynamic fragmentation were introduced. Thereafter, IEEE 802.11be is being researched, which aims to theoretically achieve a speed of 46 Gbps by supporting up to 320 MHz ultra-wide channels, multi-link operation, and 4 kQAM.

The above information is presented as background information only to assist with an understanding of the disclosure. No determination has been made, and no assertion is made, as to whether any of the above might be applicable as prior art with regard to the disclosure.

### SUMMARY

In IEEE 802.11, a secondary channel is unavailable when the primary channel is busy. A technique for improving channel utilization through channel access using a non-primary channel (or secondary channel) in such cases is being studied, and is referred to as non-primary channel access (NPCA). To efficiently perform NPCA, it is necessary to configure a condition of an AP and/or STA capable of performing NPCA and transfer information indicating whether NPCA is performable.

In order to achieve the tasks described above, a method performed by an electronic device of a wireless LAN network includes obtaining a non-primary channel access (NPCA) information element, transmitting a frame including the NPCA information element, and performing NPCA with a station (STA) associated with the electronic device on a non-primary channel (NPCH), wherein the NPCA information element includes basic NPCA information and NPCA-enabling condition information.

In addition, a method performed by an electronic device of a wireless LAN network includes receiving a frame including a non-primary channel access (NPCA) information element, identifying whether NPCA is performable, based on the NPCA information element, and in case that the NPCA is performable, performing the NPCA on a non-primary channel (NPCH), wherein the NPCA information element includes basic NPCA information and NPCA-enabling condition information.

In addition, an electronic device of a wireless LAN network includes a transceiver, and a controller, wherein the controller is configured to obtain a non-primary channel access (NPCA) information element, transmit a frame including the NPCA information element, and perform NPCA with a station (STA) associated with the electronic device on a non-primary channel (NPCH), and wherein the NPCA information element includes basic NPCA information and NPCA-enabling condition information.

In addition, an electronic device of a wireless LAN network includes a transceiver and a controller, wherein the controller is configured to receive a frame including a non-primary channel access (NPCA) information element, identify whether NPCA is performable, based on the NPCA information element, and in case that the NPCA is performable, perform the NPCA on a non-primary channel (NPCH), and wherein the NPCA information element includes basic NPCA information and NPCA-enabling condition information.

In a method according to at least one embodiment of the disclosure, it is possible to efficiently use a carrier and increase throughput by configuring an STA and a resource capable of performing NPCA.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a wireless communication network according to an embodiment of the disclosure;

FIG. 2 illustrates an example of a structure of an electronic device performing WLAN access according to an embodiment of the disclosure;

FIG. 3 illustrates an example of a normal link setup process of a wireless LAN according to an embodiment of the disclosure;

FIG. 4 illustrates examples of a hidden node and an exposed node, and examples of RTS and CTS for solving problems of the hidden node and the exposed node according to an embodiment of the disclosure;

FIG. 5 illustrates an example of a frame structure used in an IEEE 802.11 system according to an embodiment of the disclosure;

FIG. 6 illustrates an example of a NAV configuration according to an embodiment of the disclosure;

FIG. 7 illustrates an example of TXOP according to an embodiment of the disclosure;

FIG. 8 illustrates an example of NPCA according to an embodiment of the disclosure;

FIG. 9A illustrates an example in which NPCAs collide according to an embodiment of the disclosure;

FIG. 9B illustrates an example in which NPCA is performed in case of a BSS topology including a hidden AP according to an embodiment of the disclosure;

FIG. 10 illustrates an example in which STA(s) do not need to perform NPCA according to an embodiment of the disclosure;

FIG. 11 illustrates an example of a case where an unavailable scheduling exists on an NPCH according to an embodiment of the disclosure;

FIG. 12 illustrates an example of a case where a TWT SP of an OBSS exists on an NPCH according to an embodiment of the disclosure;

FIG. 13A illustrates an example of an information element used by an AP to notify an STA of a condition under which NPCA is enabled according to an embodiment of the disclosure;

FIG. 13B illustrates an example of a control field according to an embodiment of the disclosure;

FIG. 14A illustrates an example of NPCA-enabling condition information according to an embodiment of the disclosure;

FIG. 14B illustrates an example of a TWT element format according to an embodiment of the disclosure;

FIG. 14C illustrates an example of a format of a control field included in a TWT element format according to an embodiment of the disclosure;

FIG. 14D illustrates an example of a broadcast TWT parameter set field format that is a TWT parameter information field included in a TWT element format in case of a broadcast TWT according to an embodiment of the disclosure;

FIG. 14E illustrates an example of formats related to TWT for obtaining OBSS TWT SP information according to an embodiment of the disclosure.

FIG. 15 illustrates an example in which NPCA based on an NPCA information element broadcast by an AP to an STA is performed according to an embodiment of the disclosure;

FIG. 16 illustrates an example in which a list of NPCA parameter information is included in an NPCA information element according to an embodiment of the disclosure;

FIG. 17 illustrates another example in which NPCA based on an NPCA information element broadcast by an AP to an STA is performed according to an embodiment of the disclosure;

FIG. 18A illustrates an example of a configuration of an OBSS TWT element related to NPCA-enabling condition information according to an embodiment of the disclosure;

FIG. 18B illustrates an example of the broadcast TWT information field according to an embodiment of the disclosure;

FIG. 18C illustrates an example of a restricted TWT traffic information field format included in a broadcast TWT information field format according to an embodiment of the disclosure;

FIG. 18D illustrates a format of a traffic information control field (traffic info control field) included in a restricted TWT traffic information field format according to an embodiment of the disclosure;

FIG. 19 illustrates an example of an operation of an STA according to an embodiment of the disclosure; and

FIG. 20 illustrates an example of an operation of an AP according to an embodiment of the disclosure.

### DETAILED DESCRIPTION

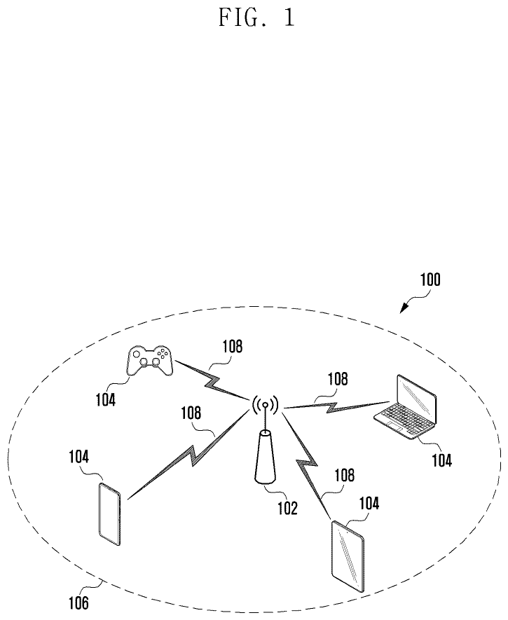

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, according to some embodiments, the “unit” may include one or more processors.

Exemplary embodiments are described below merely in relation to wireless LAN systems for simplicity. It should be understood that the exemplary embodiments are equally applicable to other wireless networks (e.g., cellular networks, pico networks, femto networks, satellite networks) as well as to systems that use signals of one or more wired standards or protocols (e.g., Ethernet and/or HomePlug, PLC standards). As used herein, the terms WLAN and Wi-Fi® may include communications governed by the IEEE 802.11 family of standards, BLUETOOTH®, HiperLAN (a set of wireless standards mainly used in Europe and comparable to the IEEE 802.11 standards), and other technologies having a relatively short wireless transmission range. Therefore, the terms WLAN and Wi-Fi may be used interchangeably herein. Additionally, the following description addresses an infrastructure WLAN system including one or more APs and multiple wireless stations (STAs), but the exemplary embodiments are equally applicable to other WLAN systems, such as systems including multiple WLANs, peer-to-peer (or independent basic service set) systems, Wi-Fi Direct systems, and/or hotspots.

Furthermore, although this disclosure describes the exchange of data frames between wireless devices, the exemplary embodiments may be applicable to the exchange of any data units, packets, and/or frames between wireless devices. Thus, the term “frame” may include any frame, packet, or, for example, data units such as protocol data units (PDUs), media access control (MAC) protocol data units (MPDUs), and physical layer (PHY) protocol data units (PPDUs). The term “A-MPDU” may refer to aggregated MPDUs. Hereinafter, a wireless LAN or WLAN network may be a network that implements at least one standard of the IEEE 802.11 family of wireless communication protocol standards which is the same as defined by the IEEE 802.11-2016 specification or its amendments (including but not limited to IEEE 802.11ah, 802.11ad, 802.11ay, 802.11ax, 802.11az, 802.11ba, and 802.11be).

In the following description, numerous specific details such as examples of specific components, circuits, and processes are provided to offer a thorough understanding of the contents of the disclosure. As used herein, the term “connected” refers to being directly connected or connected through one or more intervening components or circuits. The term “connected AP” refers to an access point with which a given wireless station is currently associated and/or connected (e.g., a communication channel or link established between the access point and the given wireless station exists). Also, in the following description and for the purpose of explanation, certain nomenclature is presented to provide a thorough understanding of the exemplary embodiments. However, it will be apparent to those skilled in the art that such specific details may not be necessary to practice the exemplary embodiments. In other cases, well-known circuits and devices are illustrated in block diagram form to avoid obscuring the disclosure. Additionally, the expression A/B refers to A and/or B, or at least one of A or B.

Hereinafter, the operation principle of the disclosure will be described in detail in conjunction with the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

FIG. 1 illustrates an example of a wireless communication network according to an embodiment of the disclosure. A wireless communication network 100 may be an example of a wireless LAN, such as a Wi-Fi network. The wireless communication network 100 may include multiple wireless communication devices such as an access point (AP) 102 and multiple stations (STAs) 104. Although only one AP 102 is illustrated, the wireless communication network 100 may include multiple APs 102.

An STA is a logical entity that includes a MAC and a physical layer interface for a wireless medium, and includes an AP and a non-AP station. Among STAs, a portable UE manipulated by a user corresponds to a non-AP STA. When used alone without additional context, the term “STA” may refer to a non-AP STA. Hereinafter, the term STA may refer to a non-AP STA. Each of the STAs 104 may be referred to as a UE or a device. As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various examples of the terminal may include a cellular phone, a smartphone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback home appliance having a wireless communication function, an Internet hole appliance capable of wireless Internet access and browsing, and portable units or terminals having integrated combinations of these functions. Furthermore, the terminal may include a machine to machine (M2M) terminal, and a machine type communication (MTC) terminal/device, but is not limited thereto. In the specification, the terminal may also be referred to as an electronic device or simply as a device.

The AP 102 is an entity that provides an STA (associated STA) associated with the AP with access to a distribution system (DS) via a wireless medium. The AP may also be referred to as a centralized controller, a base station (BS), a Node-B, a base transceiver system (BTS), or a site controller.

An exemplary coverage area 106 of the AP 102, which may represent a basic service area (BSA) of the wireless communication network 100, is illustrated. The AP 102 periodically broadcasts beacon frames (this term is usable together with the term beacon), which include a basic service set identifier (BSSID), in order to enable random STAs 104 within the wireless range of the AP 102 to be associated or reassociated with the AP 102 and establish or maintain individual communication links 108 (or may be referred to as Wi-Fi links) with the AP 102. The AP 102 may provide access to external networks for various STAs 104 within the WLAN through the individual communication links 108.

A single AP 102 and a set of associated STAs 104 may be referred to as a basic service set (BSS) managed by the corresponding AP 102. The BSS may be identified by users through a service set identifier (SSID) and may be identified by other devices through a BSSID, which may be the MAC address of the AP 102.

A BSS may be classified as an infrastructure BSS or an independent BSS (IBSS). The BSS shown in FIG. 1 is an IBSS, but it is also possible that an infrastructure BSS (not shown) is established. An infrastructure BSS includes one or more STAs and an AP. In an infrastructure BSS, communication between non-AP STAs is generally performed via the AP. However, if a direct link is established between non-AP STAs, direct communication between the non-AP STAs is also possible.

Multiple infrastructure BSSs may be interconnected via the DS. A plurality of BSSs connected through the DS is referred to as an extended service set (ESS). STAs included in an ESS may communicate with one another, and STAs may move from one BSS to another BSS within the same ESS while communicating with each other seamlessly.

The DS is a mechanism that connects multiple APs, and does not necessarily have to be a network, and there is no limitation on the form of a DS as long as the DS is able to provide a certain distribution service. For example, the DS may be a wireless network such as a mesh network or a physical structure that interconnects APs.

In addition, the AP 102 and STA 104 may be referred to as an access point multi-link device (AP-MLD) and an STA-MLD, respectively. This may indicate that the AP and STA are able to support a multi-link operation.

An example of a layered structure according to the IEEE 802.11 standard document is described below.

The IEEE 802.11 standard document develops MAC and PHY protocols corresponding to Wi-Fi wireless access technology. A data link layer (DLL) includes a MAC sublayer, and the MAC sublayer is responsible for medium access control and functions to receive packets from the upper layer, IEEE 802.1X port filtering, via a MAC_SAP interface, configure an IEEE 802.11 MAC frame, and deliver same to a physical layer. The physical layer includes a physical layer convergence procedure (PLCP) sublayer and a physical medium dependent (PMD) sublayer, and the PLCP sublayer functions to configure a PLCP frame by using the IEEE 802.11 MAC frame configured in the MAC sublayer. The PLCP frame is then transmitted to a counterpart UE through a PMD sublayer.

Various management frames managing Wi-Fi wireless access are not delivered from an IEEE 802.1X upper layer. These management frames are transmitted as requests and responses between station management entities (SMEs) located inside respective UEs. An SME is a layer-independent entity that may reside in a separate management plane or appear to exist “off to the side.” For example, if an AP wants to establish a BSS, the AP indicates beacon transmission through an MLME_SAP interface, that is, MLME-START.request and MLME-START.confirm primitives. When an STA wants to be associated with the AP, the STA indicates transmission of an association Request/Response frame through MLME-ASSOCIATE.request, MLME-ASSOCIATE.response, MLME-ASSOCIATE.confirm, and MLME-ASSOCIATE.indication primitives. If the SME wants to configure an operational parameter value related to the physical layer, the SME may configure various physical layer parameter values via a PLCP SAP interface.

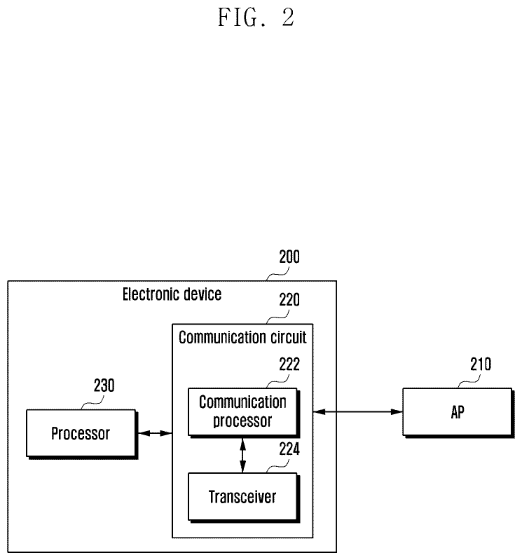

FIG. 2 illustrates an example of a structure of an electronic device performing WLAN access according to an embodiment of the disclosure. Referring to FIG. 2, an electronic device 200 may be connected to an AP 210, and the electronic device 200 may include a processor 230 and a communication circuit 220. The electronic device 200 may correspond to the STA 104 of FIG. 1, and in this case, the electronic device 200 may be connected to the AP 210 as illustrated. Alternatively, the electronic device 200 may correspond to the AP 102 of FIG. 1, and in this case, the electronic device may be connected to the STA 104 as illustrated in FIG. 1 and/or another AP.

The communication circuit 220 may transmit a communication signal to the outside or receive a communication signal from the outside, based on a Wi-Fi communication scheme (e.g., IEEE Std 802.11TM). For example, the communication circuit 220 may operate based on IEEE 802.11ac, 802.11ax, 802.11be, or 802.11bn among Wi-Fi communication schemes. In particular, IEEE 802.11be or 802.11bn may provide improved performance by supporting a wider bandwidth, higher data throughput, and lower latency compared to IEEE 802.11ax.

The communication circuit 220 may include a transceiver 224 and a communication processor 222 (e.g., a communication processor not shown, or a short-range wireless communication circuit (e.g., a Wi-Fi chipset)) for transmitting and receiving data with an external device. According to various embodiments, the communication circuit 220 may be further include memory.

According to various embodiments, the transceiver 224 may convert a baseband transmission signal into a wireless signal or convert a received wireless signal into a baseband reception signal.

According to various embodiments, the communication circuit 220 may further include, other than the transceiver 224 and the communication processor 222, elements for OFDM or orthogonal frequency division multiple access (OFDMA), such as a modulator, a digital-to-analog converter (D/A converter), a frequency converter, an A/D converter, an amplifier, and/or a demodulator.

Although not shown, according to various embodiments, the electronic device 200 may be electrically connected to a communication circuit of the AP 210 and may include at least one antenna module supporting a communication protocol and/or frequency band supported by the communication circuit of the AP 210.

The communication processor 222 may control the transceiver 224 to establish a communication connection with the AP 210. For example, the communication connection may include a Wi-Fi network. For example, the communication processor 222 may control the transceiver 224 to establish a wireless connection with the AP 210 by using a WLAN standard in the 2.4 GHz, 5 GHZ, or 6 GHz band related to IEEE 802.11ac, 802.11ax, 802.11be, or 802.11bn. Alternatively, the communication processor 222 may control the transceiver 224 to establish a wireless connection with the AP 210 by using a WLAN standard in the 60 GHz band related to IEEE 802.11ad or 802.11ay. In addition, a scheme of the electronic device 200 and the AP 210 communicating with each other by using a WLAN standard may be referred to as a communication scheme based on an STA mode.

According to an embodiment, the processor 230 may include an application processor. For example, the processor 230 may perform a designated operation of the electronic device 200 or control other hardware (e.g., the communication circuit 220) to perform a designated operation.

According to various embodiments, the AP 210 may support an operation of transmitting a packet to an external network (e.g., the Internet, an external LAN, or a cellular network) and/or an operation of receiving a packet from the external network by multiple electronic devices (e.g., the electronic device 200), based on a connection between the multiple electronic devices and the external network.

For example, the AP 210 may be a wireless router. The AP 210 may be a dedicated wireless router or a general-purpose device supporting a mobile hotspot function, and the implementation thereof is not limited. For instance, the AP 210 may include the same elements (e.g., a processor and/or a communication circuit) as in the electronic device 200. In addition, the AP 210 may also transmit and receive data with an external device such as a server. For example, the AP 210 may transmit at least a portion of data received from the server to the electronic device 200.

When the electronic device 200 of FIG. 2 corresponds to the AP 102, the electronic device 200 may include a separate communication circuit for connection with an external network, although not illustrated. This communication circuit may be controlled by the processor 230 or by a separate processor. The separate communication circuit may include a transceiver and a processor and may further include memory. In addition, the electronic device 200 may include a separate antenna module or a wired connection device for connection with the external network.

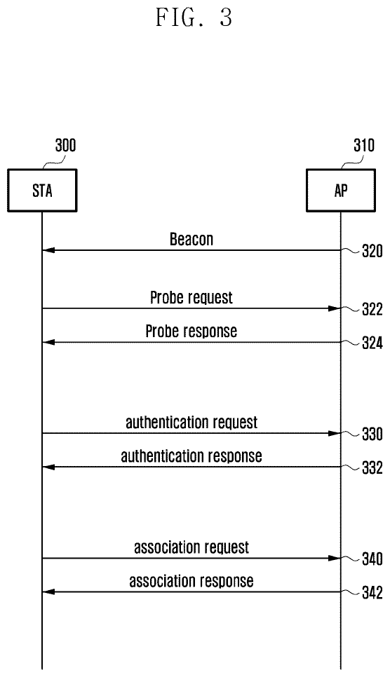

FIG. 3 illustrates an example of a normal link setup process of a wireless LAN according to an embodiment of the disclosure.

In order for an STA to set up a link for a network and transmit and receive data, the STA needs to first perform discovery of the network, authentication, establishment of an association, and an authentication procedure for security. The link setup process may also be referred to as a session initiation process or a session setup process. Furthermore, the discovery, authentication, association, and security configuration processes of the link setup process may collectively be referred to as an association process.

Referring to FIG. 3, an STA 300 may perform a network discovery operation. The network discovery operation may include a scanning operation by the STA 300. That is, in order for the STA 300 to access a network, the STA needs to find a network that the STA is able to participate in. Before participating in a wireless network, the STA 300 is required to identify a compatible network, and a process of identifying a network present in a specific area is called scanning.

A scanning scheme is classified into active scanning and passive scanning. In active scanning, the STA 300 that performs the scanning may move across channels and transmit a probe request frame 322 to search for which APs are present in the vicinity, and then wait for a response therefore. A responder transmits a probe response frame 324 to the STA having transmitted the probe request frame in response to the probe request frame. Here, the responder may be an AP or STA having lastly transmitted a beacon frame in a BSS of a channel being scanned. In FIG. 3, an example of a BSS in which an AP 310 transmits a beacon frame 320 and thus becomes a responder is illustrated. In case of an IBSS, STAs within the IBSS take turns transmitting beacon frames, and therefore the responder is not fixed. For example, if the STA transmits a probe request frame on channel 1 and receives a probe response frame on channel 1, the STA may store BSS-related information included in the received probe response frame and move to the next channel to perform scanning in the same method.

A scanning operation may also be performed in a passive scanning manner. In passive scanning, the STA that performs the scanning may move across channels to detect a beacon frame. A beacon frame is one of the management frames defined in IEEE 802.11, and is periodically transmitted to inform the presence of a wireless network and to allow an STA performing scanning to discover and participate in the wireless network. In FIG. 3, an example of a BSS in which the AP 310 periodically transmits the beacon frame 320 to the STA 300 is illustrated. In case of an IBSS, STAs within the IBSS take turns transmitting beacon frames. When the STA performing scanning receives a beacon frame, the STA stores the information on the BSS included in the beacon frame and moves to another channel to record beacon frame information on each channel. In comparison between active scanning and passive scanning, active scanning has the advantages of lower delay and reduced power consumption compared to passive scanning.

After the STA 300 discovers a network, an authentication process may be performed. This authentication process may be referred to as a first authentication process to clearly distinguish the process from a security setup operation described later. The authentication process includes a process in which the STA 300 transmits an authentication request frame 330 to the AP 310, and in response, the AP 310 transmits an authentication response frame 332 to the STA 300. An authentication frame used for authentication request/response corresponds to a management frame.

The authentication frame may include information on an authentication algorithm number, an authentication transaction sequence number, a status code, a challenge text, a robust security network (RSN), and a finite cyclic group. The information corresponds to some examples of pieces of information that may be included in an authentication request/response frame, and the information may be replaced with other information or include additional information.

The AP 310 may determine whether to permit authentication of the STA, based on information included in the received authentication request frame. The AP 310 may provide a result of authentication processing to the STA 300 through the authentication response frame.

After the STA is successfully authenticated, an association process may be performed. The association process includes a process in which the STA 300 transmits an association request frame 340 to the AP 310, and in response, the AP 310 transmits an association response frame 342 to the STA 300.

For example, the association request frame may include information related to various capabilities, and information on a beacon listen interval, an SSID, supported rates, supported channels, a robust security network (RSN), a mobility domain, supported operating classes, a traffic indication map (TIM) broadcast request, and interworking service capabilities.

For example, the association response frame may include information related to various capabilities, and information such as a status code, an association ID (AID), supported rates, an enhanced distributed channel access (EDCA) parameter set, a received channel power indicator (RCPI), a received signal to noise indicator (RSNI), a mobility domain, a timeout interval (association comeback time), overlapping BSS scan parameters, a TIM broadcast response, and a QoS map.

The information corresponds to some examples of pieces of information that may be included in an association request/response frame, and the information may be replaced with other information or include additional information.

Although not illustrated, after the STA is successfully associated with the network, a security setup process may be performed. The security setup process may be referred to as an authentication process through a robust security network association (RSNA) request/response, or the authentication process 330 may be referred to as a first authentication process, and the security setup process may also be referred to as an authentication process.

The security setup process may include, for example, a process of performing a private key setup through four-way handshaking using an extensible authentication protocol over LAN (EAPOL) frame, or may be performed according to a security scheme not defined in the IEEE 802.11 standard.

The following describes a medium access control protocol provided by IEEE 802.11.

In a wireless LAN system according to IEEE 802.11, a basic access mechanism of the MAC is based on a distributed coordination function (DCF), which uses a carrier sense multiple access with collision avoidance (CSMA/CA) scheme. There are two types of methods of sensing a carrier in the DCF, including a physical carrier sensing method and a virtual carrier sensing method. The physical carrier sensing method is a scheme of detecting a channel status at the physical layer and notifying the MAC layer, and the virtual carrier sensing method is a scheme of reserving a channel in advance by broadcasting a channel occupancy time to surrounding stations. An STA or an AP having secured a transmission channel records and transmits the channel occupancy time in RTS and/or CTS or a data frame, and other STAs having received same determine that the channel is in use during the time and do not perform channel occupancy contention, thereby avoiding collisions.

The physical carrier sensing method basically employs a listen before talk access mechanism. According to this type of access mechanism, an AP and/or an STA may, before initiating transmission, perform clear channel assessment (CCA), which involves sensing a wireless channel, carrier, or medium for a predetermined time duration. The predetermined time duration is referred to as an inter-frame space (IFS), and may vary depending on the priority of traffic to be transmitted. That is, the priority may be determined by the length of the time duration, and higher-priority packets may correspond to shorter time durations.

The IFS may include a short IFS (SIFS), a PCF IFS (PIFS), a DCF IFS (DIFS), and an arbitration IFS (AIFS). The SIFS is the shortest time duration and may be typically used as a waiting time for control information. The PIFS is a medium-length time duration and may be configured for packets with a medium level of priority (PIFS=SIFS+1 slot time). The DIFS is the longest time duration compared to the SIFS and PIFS, has a low priority, and may be typically used as the waiting time to identify whether a channel is in use (DIFS=SIFS+2 slot time). For example, an STA which intends to perform transmission may listen (or sense a channel) to whether a channel is in use during the DIFS period.

If as a result of the sensing, a medium is determined to be in an idle status, the AP and/or STA initiates frame transmission through the medium. On the other hand, if the medium is sensed to be in an occupied status, the AP and/or STA does not initiate the transmission by the AP and/or STA, and may configure a delay period for medium access (e.g., a random backoff period), wait for the period, and then attempt frame transmission. For example, the AP and/or STA may randomly select a timer value within a contention window (CW) range, wait until the timer ends, and then sense the channel again. If the medium is in an idle status, the AP and/or STA may start frame transmission. If the medium is in an occupied status, the AP and/or STA may double the size of the contention window and select a timer value again. The initially applied size of the contention window is referred to as a contention window minimum (CWmin), and the maximum applicable size of the contention window is referred to as a contention window maximum (CWmax). By applying the random backoff period, it is expected that multiple STAs may wait for different times and then attempt frame transmission, thereby minimizing collisions.

However, since the DCF scheme does not consider priorities among STAs, the scheme has difficulty in supporting various types of data transmission and quality of service (QOS). Accordingly, a hybrid coordination function (HCF) was introduced. HCF is based on the DCF and a point coordination function (PCF). PCF is a polling-based synchronous access method and refers to a scheme in which all reception APs and/or STAs periodically perform polling to receive data frames. HCF includes enhanced distributed channel access (EDCA) that is a contention-based channel access method and HCF controlled channel access (HCCA) based on a contention-free scheme using a polling mechanism. HCF also includes a medium access mechanism for improving the QoS of a WLAN, and may transmit QoS data in both a contention period (CP) and a contention-free period (CFP).

According to EDCA, data has a priority from 0 to 7 depending on the traffic type, and data arriving at the MAC layer is mapped to one of four access categories (ACs) according to the priority. The greater priority corresponds to a higher priority. Each AC has AC parameters, and a backoff is performed using differently configured AC parameter values, so that the data has different channel access priorities according to the ACs. As the AC parameters, there may be AIFS, CWmin, CWmax, and TXOP limit. Smaller values of AIFS and CWmin indicate a higher priority, thereby reducing channel access delay and allowing data to use more bands under a given traffic environment. A backoff process of EDCA, which generates a new backoff counter when a collision between STAs occurs during frame transmission, is similar to a conventional process of DCF. However, transmission based on traffic priority is ensured through an EDCA parameter including a priority per AC.

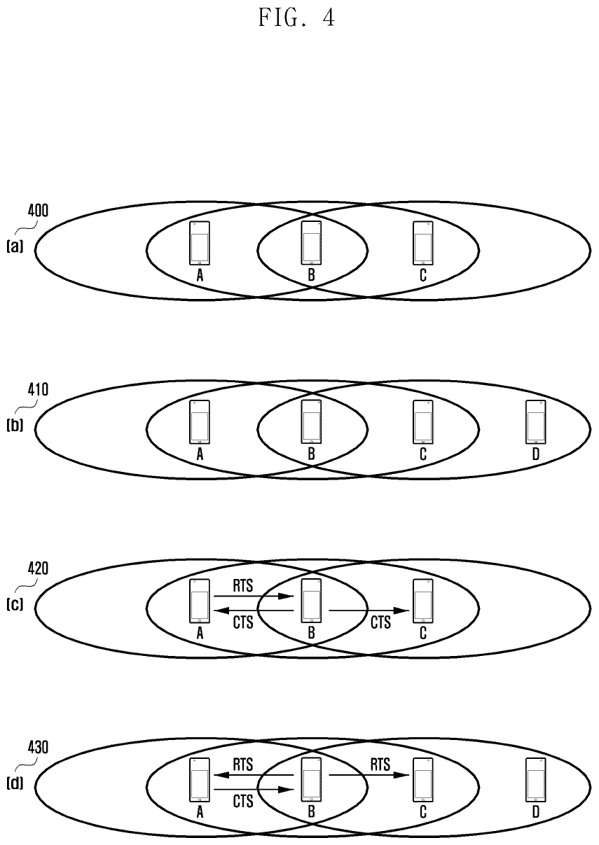

FIG. 4 illustrates examples of a hidden node and an exposed node, and examples of RTS and CTS for solving problems of the hidden node and the exposed node according to an embodiment of the disclosure.
(a)(400) in FIG. 4 shows an example for a hidden node. When STA A and STA B are in communication and STA C has data to transmit, even though STA A is transmitting information to STA B, STA C may determine that a medium is in an idle status during carrier sensing before transmitting the data to STA B. This is because STA C may fail to sense the transmission (i.e., medium occupancy) by STA A at the location of STA C. In such a case, STA B receives the information of STA A and STA C simultaneously, resulting in a collision. In this situation, STA A may be referred to as a hidden node of STA C.
(b)(410) in FIG. 4 shows an example for an exposed node. When STA B is transmitting data to STA A, STA C may have data to transmit to STA D. In this case, when STA C performs carrier sensing, STA C may determine that a medium is occupied due to the transmission by STA B. Accordingly, STA C has to wait until the medium becomes an idle status, even though STA C has information to transmit to STA D. However, in reality, since STA A is out of the transmission range of STA C, transmission from STA C and transmission from STA B may not collide from the perspective of STA A. Therefore, STA C unnecessarily waits until STA B stops the transmission. In this case, STA C may be referred to as an exposed node of STA B.

In such a situation, in order to efficiently utilize a collision avoidance mechanism, a short signaling packet such as a request to send (RTS) and a clear to send (CTS) may be used. An STA intending to transmit data transmits an RTS to an STA that is to receive the data, and the reception STA having received the RTS responds with a CTS frame to the transmission STA. The RTS and/or CTS between the two STAs may be overheard by neighboring STAs, so that the neighboring STAs consider whether information transmission is performed between the two STAs.
(c)(420) in FIG. 4 shows an example for a method of solving a hidden node problem. A case where both STA A and STA C intend to transmit data to STA B is assumed. When STA A transmits an RTS to STA B, STA B transmits a CTS to STA A. STA C having overheard the RTS and CTS delays access to a medium until the data transmission between STA A and STA B ends, thereby being able to avoid a collision.
(d)(430) in FIG. 4 shows an example for a method of solving an exposed node problem. STA B, which intends to transmit data to STA A, may transmit an RTS, and STA A, which is to receive the data, may respond to the RTS by transmitting a CTS. In this case, if STA C receives only the RTS transmitted by STA B and fails to receive the CTS transmitted by STA A, STA C may recognize that STA A is outside the carrier sensing range of STA C. In this case, STA C may determine that even if STA C transmits data to another STA (e.g., STA D), a collision may not occur, and may transmit the data.

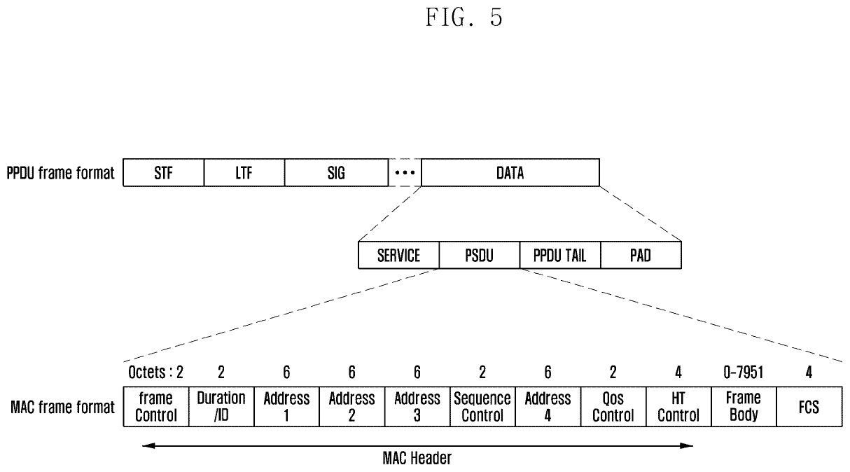

FIG. 5 illustrates an example of a frame structure used in an IEEE 802.11 system according to an embodiment of the disclosure.

A physical layer protocol data unit (PPDU) format may be configured to include a short training field (STF), a long training field (LTF), a SIGNAL field (SIG), and a data field. A most basic (e.g., a non-high throughput (non-HT)) PPDU frame format may be configured by only a legacy STF (L-STF), a legacy LTF (L-LTF), a SIG field, and a data field.

The STF may be used for frame timing acquisition, automatic gain control (AGC), diversity detection, and coarse frequency/time synchronization. The LTF may be used for fine frequency/time synchronization and channel estimation. The STF and the LTF together may be referred to as a PHY preamble, and the PHY preamble may be a signal for synchronization and channel estimation of an OFDM physical layer.

The SIG field may be used to transmit control information for demodulating and decoding a data field. The SIG field may include information on a data rate and a data length. Additionally, the SIG field may include parity bits, SIG TAIL bits, and the like.

The data field may include a SERVICE field, a physical layer service data unit (PSDU), and PPDU TAIL bits, and may also include padding bits if necessary. Some bits of the SERVICE field may be used for a descrambler at a reception end. The PSDU corresponds to a MAC protocol data unit (MPDU) defined in the MAC layer and may include data generated/used by an upper layer. The PPDU TAIL bits may be used to return an encoder to a zero status. The padding bits may be used to align the length of the data field to a predetermined unit.

The MPDU may be defined according to various MAC frame formats, and a basic MAC frame may include a MAC header, a frame body, and a frame check sequence (FCS). The MAC frame may be configured by an MPDU and may be transmitted/received through a PSDU in a data portion of the PPDU format.

The MAC header is defined as a region including a frame control field, a duration/identifier (ID) field, an address 1 field, an address 2 field, an address 3 field, a sequence control field, an address 4 field, a QoS control field, and an HT control field.

The frame control field includes information on a characteristic of the MAC frame. The duration/ID field may be implemented to have different values depending on the type and subtype of the MAC frame.

The address 1 field to the address 4 field may be used to indicate a BSSID, a source address (SA), a destination address (DA), a transmitting address (TA) indicating the address of a transmission STA, and a receiving address (RA) indicating the address of a reception STA.

The sequence control field is configured to include a sequence number and a fragment number. The sequence number may indicate a sequence number assigned to the MAC frame. The fragment number may indicate the number of each fragment of the MAC frame.

The QoS control field includes information related to QoS. The QoS control field may be included when a Subtype subfield indicates a QoS data frame. The HT control field includes control information related to an HT and/or VHT transmission/reception technique.

The frame body is defined as a MAC payload, contains data to be transmitted by an upper layer, and has a variable size. For example, a maximum MPDU size may be 11454 octets, and a maximum PPDU size may be 5.484 ms.

The FCS is defined as a MAC footer and is used for error detection of the MAC frame.

The first three fields (the frame control field, the duration/ID field, and the address 1 field) and the last field (the FCS field) configure a minimum frame format and are present in all frames. The other fields may be present only in a specific frame type.

The following describes a network allocation vector (NAV) used in a wireless LAN network.

As described above, a CSMA/CA mechanism includes not only physical carrier sensing in which an AP and/or an STA senses a medium directly, but also virtual carrier sensing. Virtual carrier sensing is intended to compensate for problems that may occur in medium access, such as the hidden node problem. For virtual carrier sensing, the MAC of a wireless LAN system may use a NAV. The NAV is a value used by an AP and/or STA currently using or having the authority to use a medium, to indicate a remaining time until the medium becomes available to another AP and/or STA. Accordingly, a value configured as the NAV corresponds to a period in which use of a medium by an AP and/or STA transmitting a corresponding frame is scheduled, and an STA receiving the NAV value is prohibited from accessing the medium during the period. The NAV may be configured, for example, according to a value of a duration field in a MAC header of a frame.

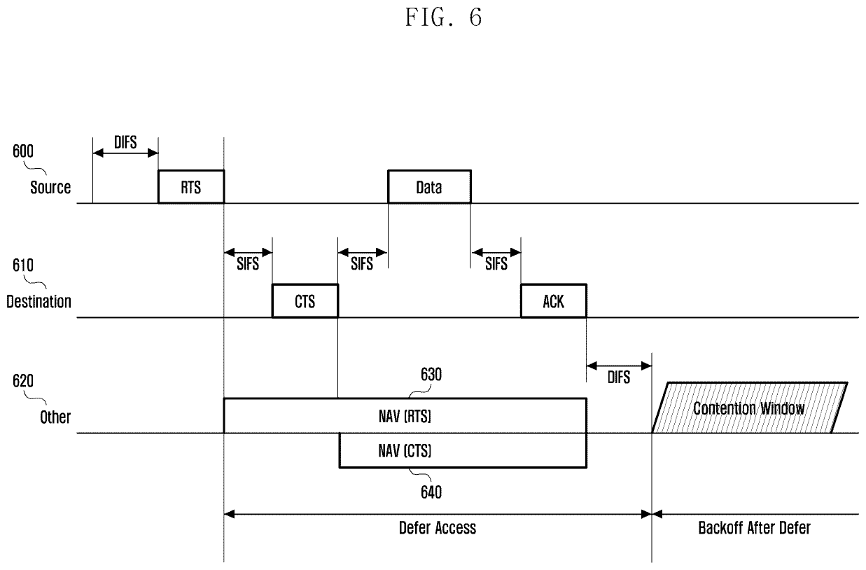

FIG. 6 illustrates an example of an NAV configuration according to an embodiment of the disclosure.

Referring to FIG. 6, a source STA 600 transmits an RTS frame after a DIFS, and a destination 610 transmits a CTS frame after a SIFS. The destination STA having been designated as a receiver through the RTS frame does not configure a NAV. Some of remaining STAs 620 may receive the RTS frame and configure a NAV (630), and others may receive the CTS frame and configure a NAV (640).

If the CTS frame (e.g., a PHY-RXSTART.indication primitive) is not received within a certain period from a time point at which the RTS frame is received (e.g., a time point at which the MAC receives a PHY-RXEND.indication primitive corresponding to the RTS frame), the STAs that have configured or updated the NAV through the RTS frame may reset the NAV (e.g., to 0) (or this case may be referred to as NAVtimeout). The certain period may be (2*aSIFSTime+CTS_Time+aRxPHYStartDelay+2*aSlotTime), and may be referred to as a NAVtimeout period. CTS_Time may be calculated based on the length and the data rate of the CTS frame indicated by the RTS frame.

In FIG. 6, for convenience, an example of configuring or updating a NAV through an RTS frame or a CTS frame is illustrated. However, NAV configuring/reconfiguring/updating may also be performed based on a duration field of various other frames, for example, a non-HT PPDU, an HT PPDU, a VHT PPDU, or an HE PPDU (e.g., a duration field in a MAC header of a MAC frame).

In addition, in IEEE 802.11ax, a basic NAV and an intra-BSS NAV were introduced. The basic NAV is always (mandatory) configured to be a NAV according to a frame transmitted by an AP or an STA other than a corresponding AP or STA, and the intra-BSS NAV may be optionally configured to be a NAV according to a frame transmitted within a BSS to which the corresponding AP or STA belongs. The corresponding AP or STA may access the medium when two NAV timers have been terminated (i.e., after both NAV time durations have elapsed).

The following describes TXOP. Transmission opportunity (TXOP) was newly introduced in the IEEE 802.11e MAC to ensure QoS and improve channel utilization. To ensure QoS, a TXOP may be used to allocate an opportunity of being preferentially transmitted when two or more packets correspond to the same access category (AC).

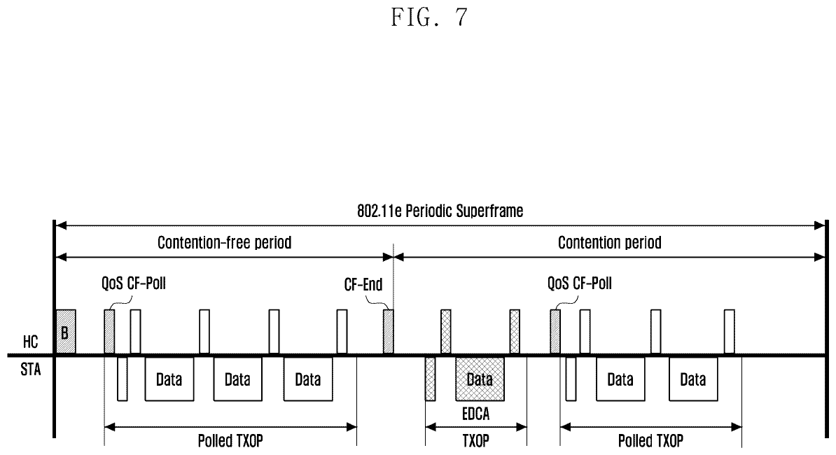

FIG. 7 is a diagram illustrating an example of TXOP. An STA participating in QoS transmission may obtain a TXOP in which transmission of traffic is possible for a certain period, by using two types of channel access methods, such as EDCA and HCCA. The TXOP acquisition may be achieved by succeeding in EDCA contention or by receiving a QoS CF-Poll frame from an AP. The former is referred to as an EDCA TXOP, and the latter is referred to as a polled TXOP. As described above, using the concept of a TXOP, a certain time may be given or the transmission time may be forcibly limited to enable a random STA to transmit a frame.

The transmission start time and the maximum transmission time of a TXOP is determined by an AP, are notified to an STA by a beacon frame in case of an EDCA TXOP, and are notified by a QoS CF-Poll frame in case of a Polled TXOP.

A NAV may be understood as a type of timer for protecting a TXOP of a transmission STA (e.g., a TXOP holder). An STA may not perform channel access during a period in which a NAV configured for the STA is valid, thereby protecting a TXOP of another STA. In a current wireless LAN system, a TXOP duration is configured through a duration field of a MAC header. That is, a TXOP holder and a TXOP responder (e.g., Rx STA) may include and transmit all TXOP information required for transmitting and receiving frames, in a duration field of a frame transmitted and received therebetween. Third STAs (e.g., third party STAs) other than a TXOP holder or TXOP responder may identify a duration field of a frame exchanged between the TXOP holder and the TXOP responder, and configure/update a NAV to defer channel use until a NAV period expires.

The following describes a primary channel and a secondary channel. A primary channel is a common channel operated by all STAs which are members of a BSS. For example, in a 20 MHz, 40 MHz, 80 MHz, 160 MHZ, or 80+80 MHz BSS, a primary channel may be a primary 20 MHz channel. In this case, a 40 MHz or 80 MHz channel that includes the primary 20 MHz channel may be referred to as a primary 40 MHz or 80 MHz channel, and the term “primary channel” may generally refer to the primary 20 MHz channel.

A secondary channel is a channel associated with the primary channel and is used to create a wider channel than the primary channel. For example, in a 40 MHz, 80 MHz, or 160 MHz BSS, a 40 MHz channel may be a sum of a primary 20 MHz channel and a secondary 20 MHz channel, an 80 MHz channel may be a sum of a primary 40 MHz channel and a secondary 40 MHz channel, and a 160 MHz channel may be a sum of a primary 80 MHz channel and a secondary 80 MHz channel.

The following describes the IEEE 802.11be standard. The IEEE 802.11be, also referred to as extremely high throughput (EHT), operates in all of the 2.4, 5, and 6 GHz bands, and is being developed to provide a maximum speed of 46 Gbps, which is approximately 4.8 times faster than Wi-Fi 6, by introducing a 320 MHz wide bandwidth, 4096-QAM, multi resource units (RUS), and multi-link operation (MLO) and provide low latency and high network throughput. Specifically, the IEEE 802.11be provides a wide bandwidth of 320 MHz in the 6 GHz band, may also allow data transmission through MU-MIMO that provides 16 spatial streams in uplink and downlink, and may adopt 4096-QAM to achieve higher transmission efficiency. Furthermore, flexible spectrum resource scheduling may be performed using multiple RUs to improve spectrum efficiency, and simultaneous data transmission and reception may be performed across various frequency bands and channels through multi-link operation.

The following describes TXOP sharing. In IEEE 802.11ac, a MU-MIMO MAC technology for enhancing the efficiency of a wireless channel by using spatially divided multiple channels to simultaneously transmit different frames from an AP to multiple STAs was introduced. In this case, the AP determines a destination STA and a frame to be transmitted for each channel during a TXOP period, based on an access category (AC, or priority) of the frame to be transmitted, and transmits determined multiple frames to the multiple STAs. Recently, TXOP sharing between APs has been studied. Through TXOP sharing between APs, an AP having a TXOP may share the TXOP with another AP, thereby efficiently utilizing frequency and spatial resources so as to increase network throughput and reduce latency.

Next, overlapping basic service set (OBSS) is described. In a conventional wireless LAN network, the performance such as transmission rate significantly decreases as the number of users increases. This is because a wireless LAN system basically uses a CSMA/CA scheme, which corresponds to time division access control, and thus when a neighboring network is detected, the frequency resources of the same band are shared during the activity time of the neighboring network.

Currently, multiple APs often operate in a specific area, and in such cases, performance degradation of a wireless LAN network occurs due to coverage overlap among the APs. This is because an AP of each BSS and STAs connected to the AP are affected by a signal of a neighboring BSS, and thus are interfered with by the neighboring BSS, resulting in a reduction in transmission rate due to collisions between signals transmitted at the same time. A BSS that may affect signal transmission (or overlaps in coverage) as described above may be referred to as an overlapping BSS (OBSS). To address this problem, interference avoidance techniques, in which respective bands usable by users are separately used so as not to be overlapped or channel switching to an unused channel is performed, and interference alignment techniques, which enables reduction in the impact of interference even when using the same band, have been studied.

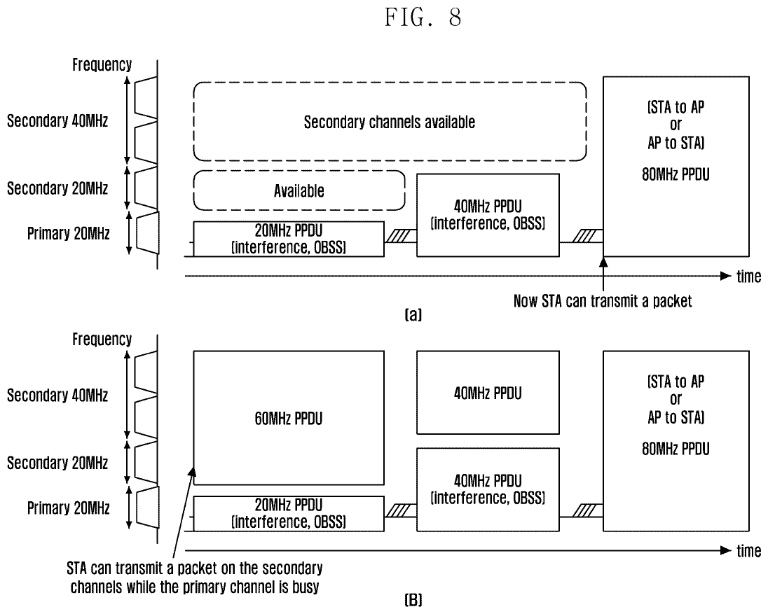

FIGS. 8A and 8B illustrate non-primary channel access (NPCA) according to an embodiment of the disclosure. In FIGS. 8A and 8B, an example in which a wideband channel is configured by a 20 MHz primary channel (i.e., a primary 20 MHz channel) and multiple 20 MHz secondary channels (i.e., secondary 20 MHz channels) is illustrated. This is for convenience of explanation, and the disclosure is not limited thereto.

According to the current IEEE 802.11 standard, in a random transmission (e.g., transmission on a 20, 40, 80, 160, or 320 MHz channel), a primary channel (i.e., a primary 20 MHz channel) needs to be idle in order to access a wideband channel wider than 20 MHz. Accordingly, when the primary channel is busy (i.e., occupied), an AP and/or STA is unable to perform transmission on a random secondary channel being idle. That is, when the primary channel is busy, it is not possible to perform transmission on a secondary channel even if the secondary channel is idle.

For example, referring to FIG. 8A, even if a secondary 20 MHz channel and a secondary 40 MHz channel are available, when a primary channel is busy, it is not possible to perform transmission. For example, the primary channel may be busy due to interference caused by a 20 MHz PPDU corresponding to an overlapping BSS (OBSS), and in this case, even if 60 MHz of secondary channels are available, it is not possible to perform transmission. In addition, the primary channel may be busy due to interference caused by a 40 MHz PPDU corresponding to an OBSS, and in this case, even if 40 MHz of secondary channels are available, it is not possible to perform transmission.

That is, according to the current IEEE 802.11 standard, an STA is allowed to transmit a packet when a primary channel is idle. That is, when the primary channel is idle, the STA may perform transmission (e.g., transmission of an 80 MHz PPDU) by using the primary channel and a secondary channel. This is equally applied to downlink (DL) transmissions of an AP as well as uplink (UL) transmissions of the STA.

Accordingly, a current secondary channel access mechanism (or scheme) is inefficient in the case of a wideband channel (e.g., a 160 MHz channel or a 320 MHz channel) or a large bandwidth, and thus a better secondary channel access mechanism (or scheme) is needed to fully utilize a wideband channel.

As a method for solving the above-described problem, non-primary channel access (NPCA) is being discussed. NPCA may be triggered based on an OBSS PPDU and/or an OBSS TXOP. According to NPCA, when a primary channel is busy and a secondary channel is available, an AP and/or STA is able to transmit a frame on the available secondary channel. Hereinafter, NPCA may refer to channel access and/or frame exchange on a secondary channel (when the primary channel is busy).

A NPCA primary channel may be defined among (or within) secondary channels. The NPCA primary channel may be a channel on which channel access (e.g., EDCA) is performed while the primary channel is busy. That is, the NPCA primary channel may be a 20 MHz channel with the secondary channels on which channel access is performed while the primary channel is busy. The NPCA primary channel may be referred to as an anchor channel, but the disclosure is not limited to this specific name.

For example, referring to FIG. 8B, when a primary channel is busy, transmission may be performed on available secondary channels. For instance, if the primary channel is busy due to interference caused by a 20 MHz PPDU related to an OBSS, an STA may transmit a packet (e.g., a 60 MHz PPDU) on the available secondary channels while the primary channel is busy. Channel access may be performed on an anchor channel within the secondary channels, and accordingly, if the anchor channel is idle, the packet may be transmitted on the secondary channels. This is equally applied to DL transmissions of an AP as well as UL transmissions of the STA.

For instance, if the primary channel is busy due to interference caused by a 40 MHz PPDU related to an OBSS, an STA may transmit a packet (e.g., a 40 MHz PPDU) on the available secondary channels while the primary channel is busy. Channel access may be performed on an anchor channel within the secondary channels, and accordingly, if the anchor channel is idle, the packet may be transmitted on the secondary channels. This is equally applied to DL transmissions of an AP as well as UL transmissions of the STA.

In a description of an embodiment of the disclosure, an NPCA AP may refer to an AP having a capability to perform NPCA (or an AP that performs/is capable of performing an operation related to NPCA), and an NPCA STA may refer to an STA associated with the NPCA AP and having a capability to perform NPCA (or an STA that performs/is capable of performing an operation related to NPCA). Unless otherwise specified, the terms AP, NPCA AP, STA, and NPCA STA may be used interchangeably in the disclosure.

Secondary channels on which NPCA is to operate and an anchor channel (e.g., a 20 MHz anchor channel) on which a channel access (e.g., EDCA) procedure is to be performed within the secondary channels may be pre-configured or pre-agreed between an NPCA AP and/or an NPCA STA within a BSS. The secondary channels on which NPCA operates may be referred to as non-primary channels (NPCHs), but the disclosure is not limited to such specific name.

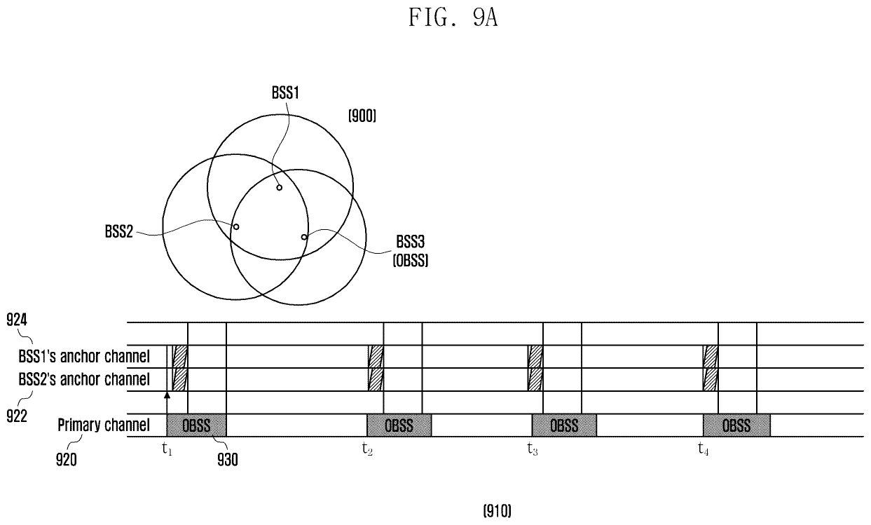

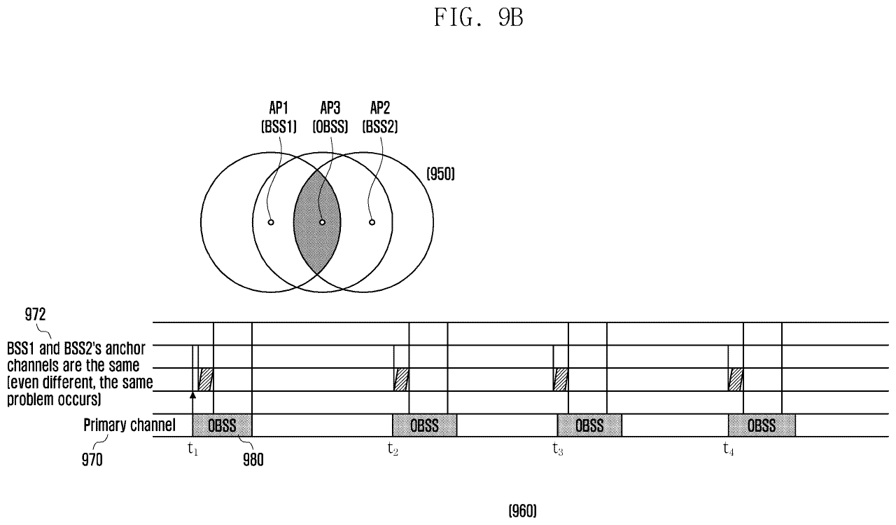

FIG. 9A and FIG. 9B illustrate a problem which may occur when NPCA is performable according to an embodiment of the disclosure.

FIG. 9A illustrates an example in which NPCAs collide. According to FIG. 9A, BSSs 1, 2, and 3 may be overlapped as indicated by reference numeral 900, and BSS 3 may correspond to an OBSS with respect to BSSs 1 and 2. According to reference numeral 910, each of BSSs 1 and 2 detects the same OBSS traffic 930 (which may be traffic of BSS 3) on a primary channel 920, and performs a channel access procedure for NPCA on an anchor channel of each BSS (an anchor channel 924 for BSS 1 and an anchor channel 922 for BSS 2). In this case, even if the anchor channels of BSSs 1 and 2 are different or the same, an NPCH of BSS 1 and an NPCH of BSS 2 may fully or partially overlap. In such a case, if BSSs 1 and 2 perform CCA on respective anchor channels, and then perform backoff for the channel access procedures with the same count, NPCA of BSS 1 and NPCA of BSS 2 may collide. The term “NPCAs collide” below may refer to a case in which the channel access procedures are performed on channels that are at least partially overlapped, resulting in a failure of frame exchange by at least some APs and/or STAs.

FIG. 9B illustrates an example in which NPCA is performed in case of a BSS topology including a hidden AP according to an embodiment of the disclosure. According to FIG. 9B, when BSSs 1 and 2 are arranged as indicated by reference numeral 950, a BSS of AP3 may correspond to an OBSS with respect to BSSs 1 and 2. In this case, AP 1 of BSS 1 and AP 2 of BSS 2 may be in a hidden relationship with each other. As indicated by reference numeral 960, if the BSS of AP 3 (i.e., the OBSS) transmits traffic 980 on a primary channel 970 of BSSs 1 and 2, the traffic may trigger channel access on NPCHs of BSSs 1 and 2. In this case, BSSs 1 and 2 move to the NPCHs and perform NPCA if an anchor channel of each BSS is idle. If the NPCHs of BSSs 1 and 2 are at least partially overlapped, a frame exchange of BSS 1 and a frame exchange of BSS 2 during NPCA may be collisions with each other.

As described above, even when NPCA is performed, multiple BSSs may simultaneously perform NPCA due to the same OBSS, as indicated by reference numeral 900 in FIG. 9A or reference numeral 950 in FIG. 9B, thus collisions between NPCA operations of the multiple BSSs may occur. In such cases, frame exchanges performed during NPCA may collide with each other, and without a valid frame transmission on an NPCH, an AP and an STA are required to move to the primary channel before a predetermined time and synchronize with the primary channel. Therefore, in order to reduce the probability of collisions between the multiple BSSs that may potentially occur during NPCA, it is necessary to configure a condition of a STA capable of performing NPCA, thereby preventing execution of NPCA by an unnecessary large number of STA(s). For example, in case of reference numeral 950 in FIG. 9B, even if BSSs 1 and 2 simultaneously perform NPCA, when an STA performing an NPCA operation in BSS 1 and an STA performing an NPCA operation in BSS 2 are in a hidden relationship and thus simultaneous transmission is possible, the respective NPCA operations do not collide. However, if the STAs performing the NPCA operations are within range of receiving each other's signals, collisions may occur. Accordingly, the probability of NPCA collisions may be reduced by reducing the number of STAs performing an NPCA operation or adjusting an operation time duration.

In addition, an NPCA operation refers to a limited-time operation in which STAs opportunistically and temporarily move to secondary channels and perform channel access due to an OBSS preoccupying a primary channel. Accordingly, the number of STAs capable of frame transmission within a single NPCA performance time may be limited. Therefore, not all STAs move to an NPCH even when OBSS traffic is detected, only STAs expected to perform frame exchange through NPCA may perform NPCA, the remaining STAs may remain on a primary channel and perform a power reduction operation (e.g., sleep).

The following describes a condition of AP and/or STA(s) capable of performing NPCA.

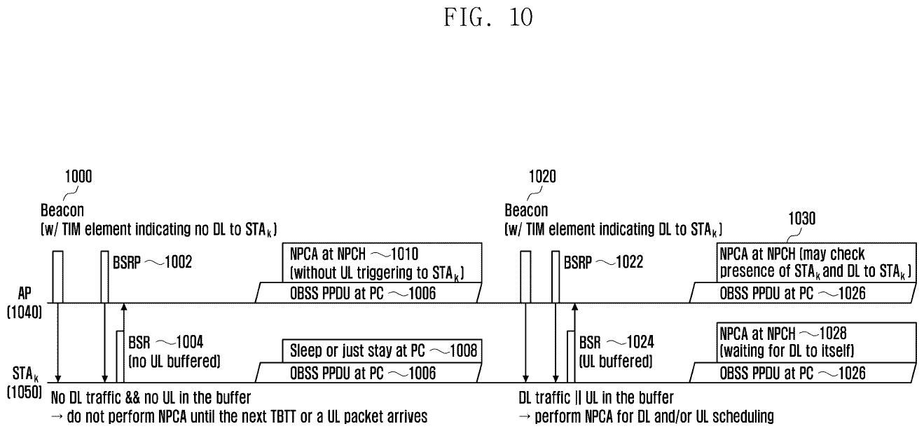

FIG. 10 illustrates an example in which STA(s) do not need to perform NPCA according to an embodiment of the disclosure. Referring to FIG. 10, for example, a beacon 1000 transmitted by an AP 1040 may include a traffic indication map (TIM) that indicates, to an STA 1050 and in a bitmap format, an STA(s) which is subject to DL traffic to be transmitted. The STA 1050 may receive the beacon and identify, based on TIM information, that the AP 1040 has no DL traffic to transmit the STA. In addition, the AP 1040 may transmit a buffer status report poll (BSRP) 1002 (or a trigger frame including the BSRP) to the STA 1050 in order to identify whether the STA 1050 has UL traffic to transmit to the AP 1040. The STA (1050) may report, through a buffer status report (BSR) 1004, that the STA (1050) has no UL traffic to transmit. That is, in this case, there is no traffic to be transmitted between the AP 1040 and the STA 1050 and, even if a primary channel is unavailable due to an OBSS PPDU 1006, the STA 1050 may remain in a sleep status or take no action (1008). In this case, the AP may perform NPCA with remaining STAs on an NPCH, excluding the STA 1050 which the AP has no DL traffic to transmit to and is identified as having no UL traffic through on the recent BSRP. In this case, the AP does not perform UL triggering for the STA 1050 during the NPCA (1010).

The STA 1050 is not required to perform NPCA before receiving, from the AP, a beacon including TIM information or receiving a TIM element frame including the TIM information at a next target beacon transmission time (TBTT) and identifying that there is DL traffic to be transferred to the STA, or before UL traffic occurs. The messages or frames are merely examples, and a message that indicates the presence or absence of traffic may correspond to this kind of example.

On the contrary, for example, a beacon 1020 transmitted by the AP 1040 may include a TIM including an indication that there is DL traffic to be transmitted to the STA 1050. The STA 1050 may receive the beacon and identify that the AP 1040 has DL traffic to transmit the STA. In addition, the AP 1040 may transmit a BSRP 1022 to the STA 1050 in order to identify whether the STA 1050 has UL traffic to transmit to the AP 1040. The STA (1050) may report, through a BSR 1024, that the STA (1050) has UL traffic to transmit (is UL buffered). That is, in this case, there is traffic to be transmitted between the AP 1040 and the STA 1050 and thus, if the primary channel is unavailable due to an OBSS PPDU 1026, the STA 1050 has a benefit in performing NPAC for DL and/or UL scheduling. In this case, the STA 1050 may perform NPCA on the NPCH to wait for DL scheduling (1028), and the AP 1040 may perform NPCA to identify whether the STA 1050 exists on the NPCH, and transmit DL traffic to the STA 1050 (1030). The messages or frames are merely examples, and a message that indicates the presence or absence of traffic may correspond to this kind of example.

That is, as described above, if an AP has no DL traffic to transmit or an STA has no UL traffic to transmit, the AP and the STA do not need to perform NPCA.

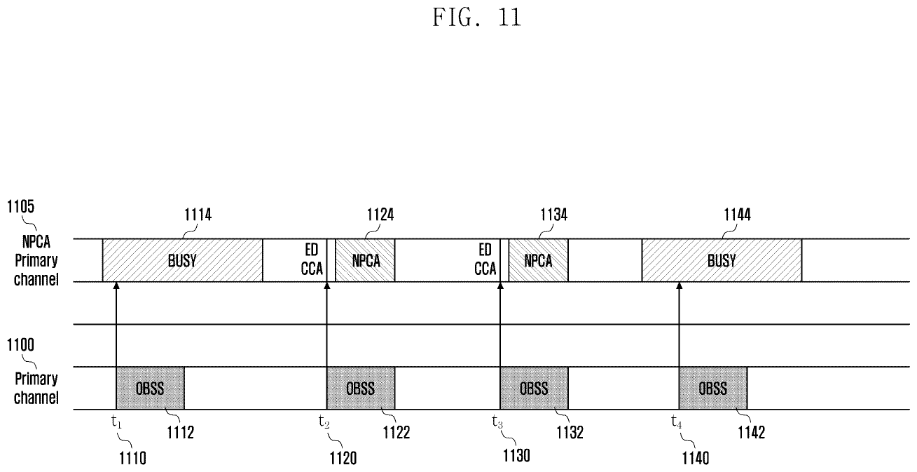

FIG. 11 illustrates an example of a case where an NPCH is unavailable due to a different OBSS thereon at a time point of starting NPCA according to an embodiment of the disclosure. If periodic traffic exists or traffic load is high on an NPCA primary channel (or anchor channel) or an NPCH, an AP may notify associated STAs of scheduling (or a list of time resources) of traffic of an OBSS operating on the NPCH, and since frame exchange on the NPCH is not possible due to frame exchange already operating on the NPCH in a time duration in which the traffic of the OBSS operating on the NPCH occurs, the STAs may be located on a primary channel without performing an operation, rather than performing NPCA.

FIG. 11 illustrates an example in which periodic traffic exists on an NPCH according to an embodiment of the disclosure. According to FIG. 11, if traffic 1112, 1122, 1132, and 1142 of an OBSS exists on a primary channel 1100, an STA may perform NPCA. In case of t1 1110 and t4 1140 at which an NPCA primary channel 1105 is busy (1114 and 1144), the STA is unable to perform channel access on the NPCA primary channel because the NPCA primary channel 1105 is busy. An AP and the STA are unable to know the length of the OBSS traffic 1114 and 1144 of the NPCA primary channel in advance. Therefore, one method is for the AP and the STA to wait until a time point at which the OBSS traffic of the NPCA primary channel ends and thus channel access is possible. However, since the AP and the STA need to change an operating channel to the primary channel before the primary channel OBSS traffic 1112 ends, there may be insufficient time for occupying the channel and performing a valid frame exchange after the OBSS traffic of the NPCA primary channel ends. In this case, since no benefit is obtained by the AP and the STA from performing NPCA, it may be advantageous not to perform NPCA. On the contrary, in case of t2 1120 and t3 1130 at which the NPCA primary channel 1105 is idle (1124 and 1134), the STA may perform NPCA on the NPCA primary channel. If the OBSS traffic 1114 and 1144 of the NPCA primary channel corresponds to a target wake time (TWT) service period (SP) of a BSS operating on the NPCA primary channel and thus occurs periodically, and the AP and STA are able to recognize information of the TWT SP in advance, even when OBSS traffic of the primary channel is detected (in the situation of t1 1110 and t4 1140) in the time durations 1114 and 1144 in which the OBSS traffic of the NPCA primary channel occurs, the AP may notify the STA not to perform NPCA in advance. Information notifying of a periodic time such as the occurrence time of the periodic traffic may include a timestamp (or start time or offset based on a specific time) of an expected start time point at which the traffic occurs and a time duration (the length of the time duration) of a service period (SP) in which the traffic occurs, similar to TWT scheduling.

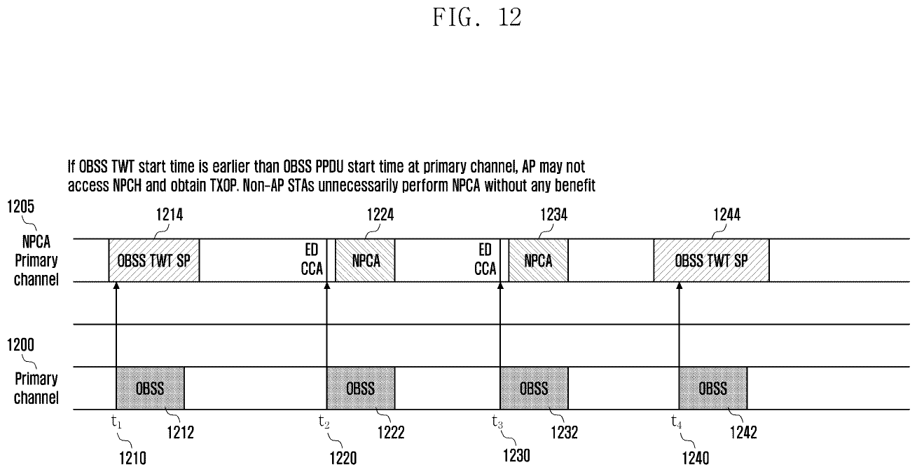

FIG. 12 illustrates an example of a case where a TWT SP of an OBSS exists on an NPCH according to an embodiment of the disclosure. TWT is configured to allow an STA to wake up in a designated service period and may help reduce power consumption and minimize contention among STAs through time division. A TWT configuration may be configured for each individual STA or a set of STAs, and TWT configuration information may include at least one piece of information of the start time (e.g., offset) of a TWT service period, the length of the service period (i.e., the awake period), and the time interval between consecutive service periods.

According to FIG. 12, if traffic 1212, 1222, 1232, and 1242 of an OBSS exists on a primary channel 1200, an AP and an STA may perform NPCA. In case of t1 1210 and t4 1240 that are time points in time durations in which an NPCA primary channel 1205 is busy due to OBSS TWT SPs (1214 and 1244), since the NPCA primary channel 1205 is busy and thus there is no opportunity to perform NPCA to occupy an NPCH and exchange a frame, the AP and the STA do not need to perform NPCA. Specifically, if an OBSS TWT start time precedes an OBSS PPDU start time of the primary channel, the AP may fail to access the NPCH and occupy a TXOP, and thus, the AP and the STA do not need to perform NPCA. On the contrary, in case of t2 1220 and t3 1230 at which the NPCA primary channel 1205 is idle (1224 and 1234), it is meaningful for the STA to perform NPCA on the NPCA primary channel, and thus the AP and the STA may perform NPCA.

As described with reference to FIG. 11 and FIG. 12, if an AP knows periodic traffic scheduling or TWT scheduling on an NPCH, the AP may notify an STA of a particular time duration in which there is no need to perform NPCA.

As described above, the AP may notify the STA of a condition in which NPCA is enabled, whether the STA is able to perform NPCA, and/or a time resource on which performance of NPCA has a low validity and thus is not to be performed. In addition, the AP may receive configuration information regarding periodic traffic or TWT from an OBSS AP. Next, an information element for notifying the above pieces of information provided in the disclosure is described.

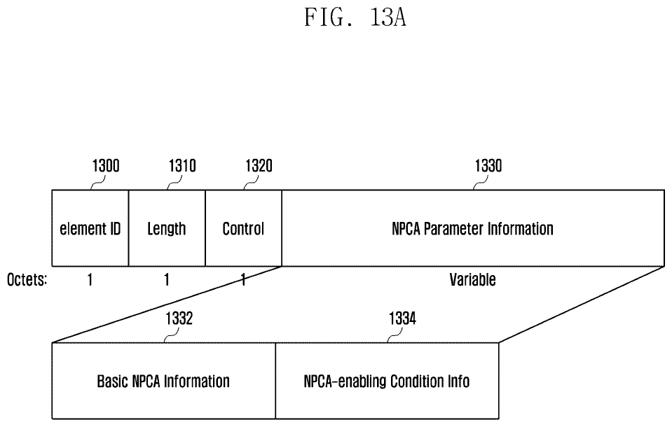

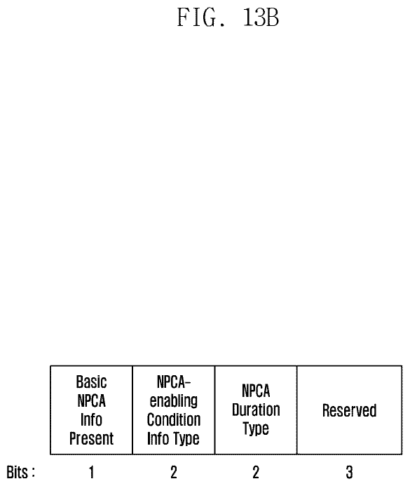

FIG. 13A illustrates an example of an information element used by an AP to notify an STA of a condition under which NPCA is enabled according to an embodiment of the disclosure. According to FIG. 13A, NPCA-enabling condition information (NPCA-enabling condition info), which may be included in an NPCA information element, is provided. The above name is merely an example, and the contents of the disclosure is not limited by the name. The NPCA information element may include an element identifier (ID) field 1300, a length field 1310, a control field 1320, and an NPCA parameter information field 1330. The NPCA parameter information field 1330 may have a variable length and may include basic NPCA information 1332 and NPCA-enabling condition information (NPCA-enabling condition info) 1334. The information element may be included in a beacon, a probe response, an (re) association response, and new management and action frames. The structure of the information element is merely an example.

FIG. 13B illustrates an example of the control field 1320 of FIG. 13A according to an embodiment of the disclosure. When the control field is 1 byte, the control field may include some or all of the following subfields.

A basic NPCA information present field (basic NPCA info present field) indicates whether a basic NPCA information parameter is present in NPCA parameter information. For example, if the value of the basic NPCA information present field is 1, basic NPCA information is present, and if the value is 0, same may not be present.

An NPCA-enabling condition information type field (NPCA-enabling condition info type field) may indicate the presence or absence and the configuration of a NPCA-enabling condition information parameter in the NPCA parameter information. The NPCA-enabling condition information type field may be 2 bits, and if the most significant bit (MSB) is 1, this may indicate that an NPCA-enabling condition information field (NPCA-enabling condition info field) is present, and depending on the least significant bit (LSB), two different elements may be represented. The NPCA-enabling condition information type field may be more than 2 bits. For example, the values of the NPCA-enabling condition information type field may be as follows.

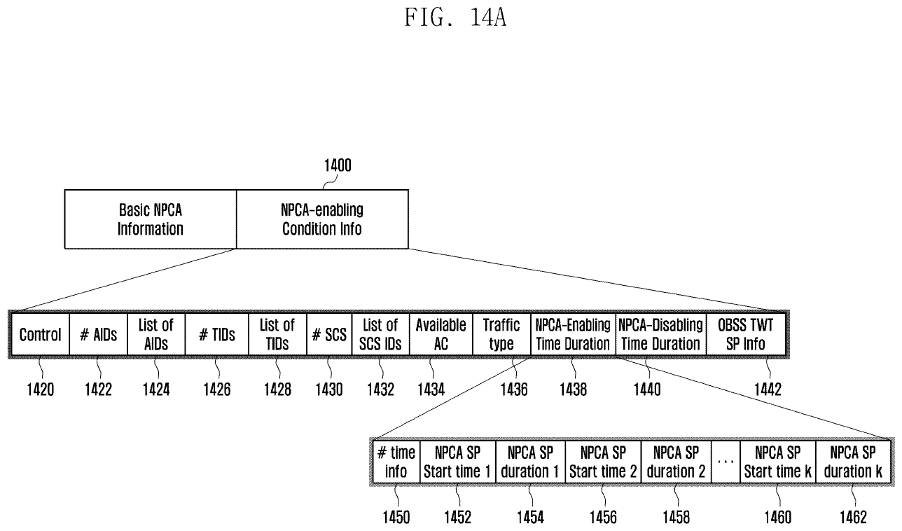

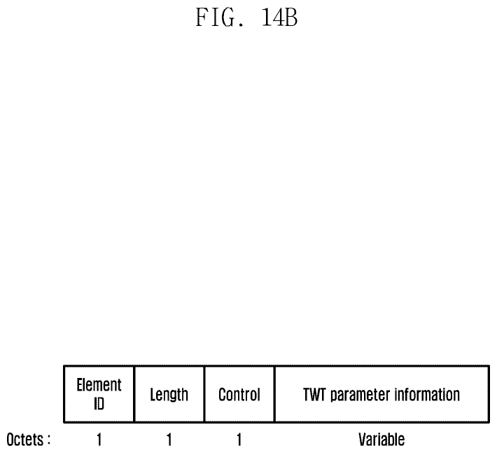

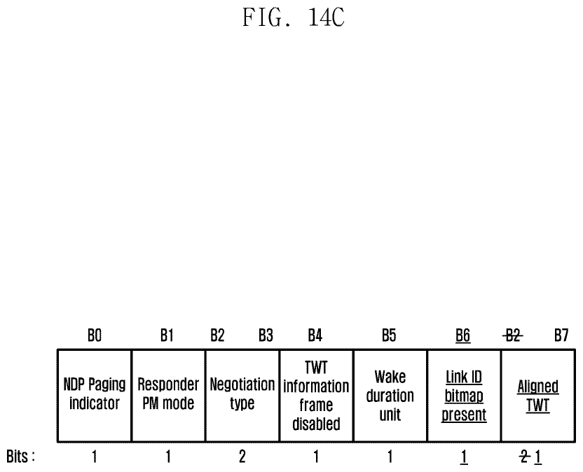

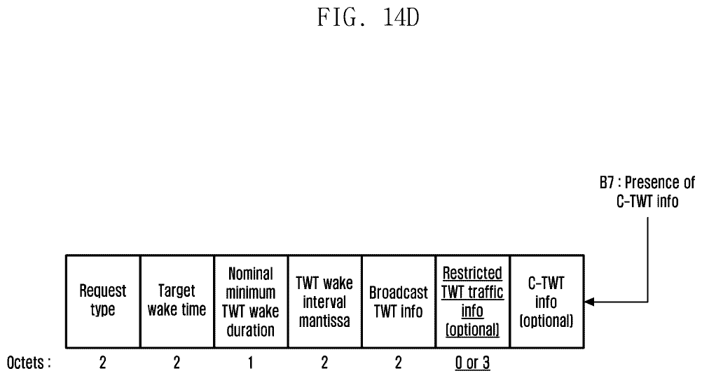

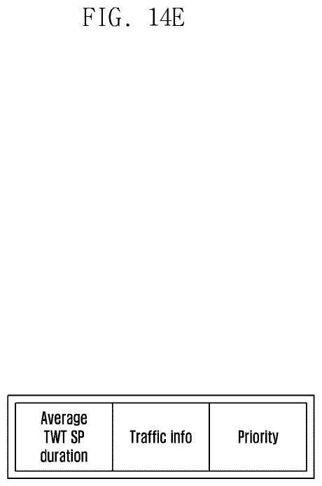

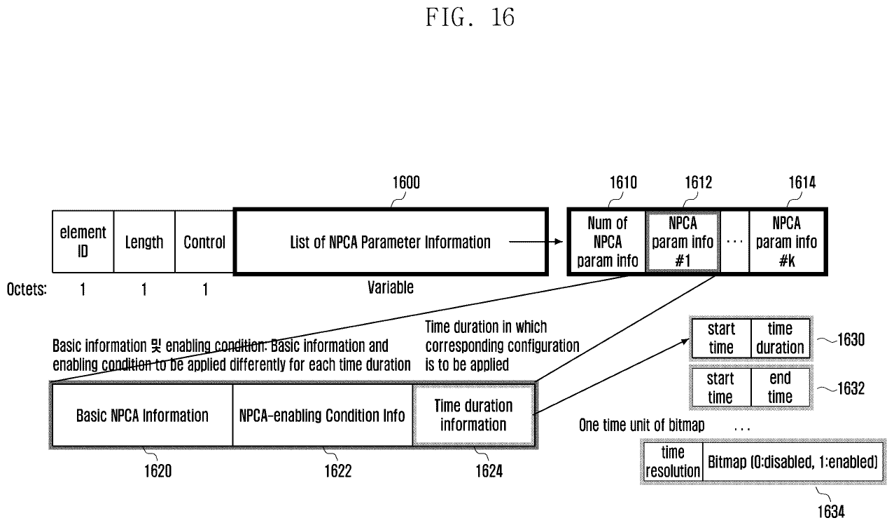

If the value of the NPCA-enabling condition information type field is 0, the NPCA-enabling condition information parameter does not exist in the NPCA parameter information and may indicate that NPCA is not to be performed. If the value is 1, the NPCA-enabling condition information parameter does not exist in the NPCA parameter information and may indicate that NPCA is to be performed without restriction. If the value is 2, the NPCA-enabling condition information parameter exists in the NPCA parameter information, and a type 1 NPCA-enabling condition information configuration may be followed. An example of the type 1 configuration may correspond to FIG. 14A. If the value is 3, the NPCA-enabling condition information parameter exists in the NPCA parameter information, and a type 2 NPCA-enabling condition information configuration may be followed. An example of the type 2 configuration may correspond to FIG. 16.

NPCA duration type may indicate a value that specifies a time duration during which NPCA is performed. For example, the value of an NPCA duration type field may be as follows. If the value of the NPCA duration type field is 0, NPCA may be limited by an OBSS PPDU transmission time on a primary channel. If the value is 1, NPCA may be limited by an OBSS TXOP length on the primary channel.

For example, the basic NPCA information 1332 may include at least one of information on an anchor channel (e.g., at least one of pieces of information such as a channel number and a bandwidth), information on an NPCH (e.g., at least one of pieces of information such as a channel number and a bandwidth), a modulation and coding scheme (MCS) and/or the number of spatial streams (NSS) available on the NPCH, and other NPCA-related information (e.g., MAC and PHY configuration information) necessary for performing NPCA.

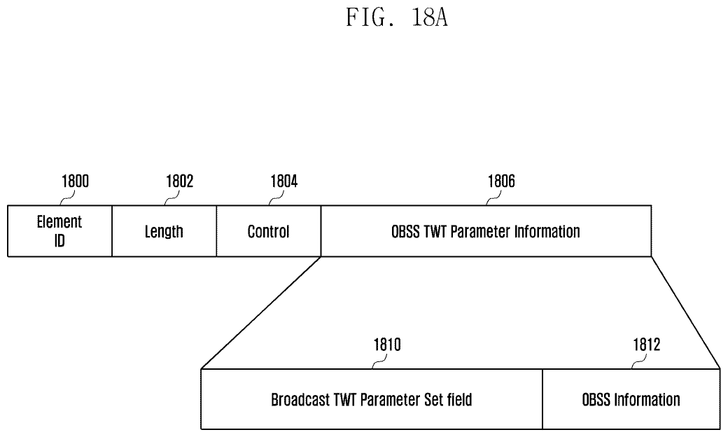

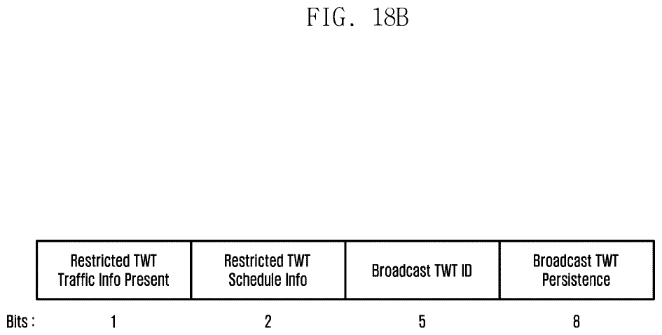

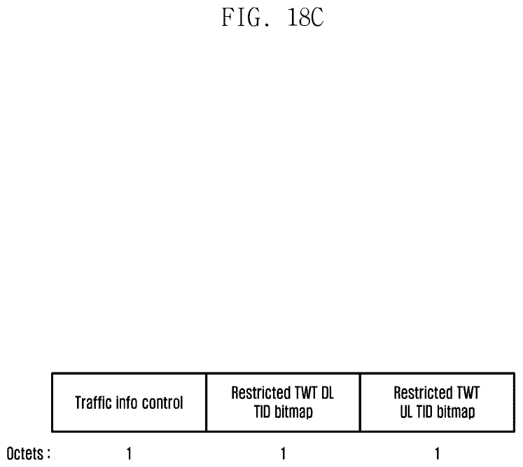

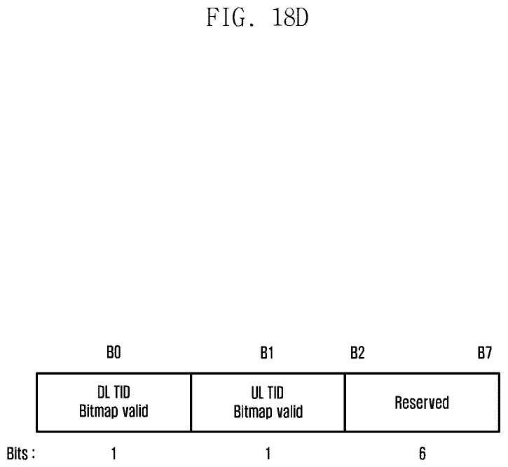

The NPCA-enabling condition information 1334 may be information indicating an STA capable of performing NPCA and a characteristic of traffic for which NPCA is enabled. For example, the NPCA-enabling condition information 1334 may include at least one of pieces of information, such as a list of AIDs capable of performing NPCA, a traffic identifier (TID) for which NPCA is performable, a stream classification service (SCS) ID for which NPCA is performable, an AC (typically in case of UL) for which NPCA is performable, a time duration during which NPCA is performable and/or a time duration during which NPCA is not transformable, and whether to avoid an OBSS TWT SP. Information indicating whether to avoid an OBSS TWT SP may be a value configured to prevent an STA from automatically performing NPCA during an OBSS TWT SP scheduling time when an AP provides the STA with TWT SP scheduling information of OBSSs operating on an NPCH. OBSS TWT SP information may be provided by OBSS TWT parameter information shown in FIG. 18 or an OBSS TWT SP information field shown in FIG. 14A or FIG. 16. The NPCA-enabling condition information may be information indicating an STA capable of performing NPCA and a characteristic of traffic for which NPCA is enabled.

The specific information included in the basic NPCA information 1332 and the NPCA-enabling condition information 1334 described above is merely an example, and may not be included in the basic NPCA information 1332 and the NPCA-enabling condition information 1334 and may be included in the NPCA-enabling condition information (NPCA-enabling condition info), or may omit some of the information or include additional information.

The contents of the information element in FIG. 13 correspond to an example, and the contents of the disclosure are not limited by the contents described above.

FIG. 14A illustrates an example of NPCA-enabling condition information according to an embodiment of the disclosure. NPCA-enabling condition information may be 1 octet or 2 octets according to the number of subfields. According to FIG. 14A, NPCA-enabling condition information 1400 may include at least one of the following pieces of information. In addition, it is also possible to include information obtained by joint encoding of two or more of the following pieces of information:
Control 1420;
Number of association identifiers (AIDs)(#AIDs) 1422;
List of AIDs 1424: A list including the values of AIDs capable of performing NPCA;
Number of traffic identifiers (TIDs)(#TIDs) 1426;
List of TIDs 1428: A list including the values of TIDs capable of performing NPCA;
Number of stream classification service (SCS) IDs (#SCS) 1430;
List of SCS IDs 1432: A list including SCS ID values for which NPCA is performable;
Available access category (AC) 1434: This means an AC of traffic transmittable or receivable through NPCA;
Traffic type 1436: This indicates the type of traffic transmittable or receivable through NPCA, and may include whether the traffic is periodic (periodic traffic), the urgency level of the traffic (traffic priority), or a traffic delay bound;
NPCA-enabling time duration 1438;
NPCA-disabling time duration 1440;
OBSS TWT SP information (OBSS TWT SP info) 1442: The information may include TWT SP scheduling information operated by APs operating on an NPCH, and cause an STA not to perform NPCA in a time duration corresponding to a corresponding OBSS TWT SP. OBSS TWT SP scheduling information may be obtained by an AP through a beacon or broadcast message from an OBSS AP. Since the obtained information may be based on a clock and a TBTT of the OBSS AP, the AP may, before providing OBSS TWT SP information to an STA, perform time correction based on the clock and TBTT time point of the AP and provide relevant information to the STA; and/or
Unit of time duration: This indicates, for example, ns or TU, and may be used to indicate at least one of the NPCA-enabling time duration, the NPCA-disabling time duration, or the OBSS TWT SP information.

Detailed information of the OBSS TWT SP information may be provided by a TWT element format, and an OBSS element format described with reference to FIG. 14B to FIG. 14E, and/or OBSS TWT parameter information described with reference to FIG. 18A may be referenced as an example of the TWT element format.

FIG. 14B, FIG. 14C, FIG. 14D, and FIG. 14E illustrate examples of formats related to TWT for obtaining OBSS TWT SP information according to an embodiment of the disclosure.

FIG. 14B illustrate an example of a TWT element format according to an embodiment of the disclosure. Referring to FIG. 14B, a TWT element format may include a 1-octet element ID field, a 1-octet length field, a 1-octet control field, and a variable-octet TWT parameter information field.

FIG. 14C illustrates an example of a format of a control field included in a TWT element format according to an embodiment of the disclosure. Referring to FIG. 14C, a format of a control field may include a null data packet (NDP) paging indicator field, a responder PM mode field, a negotiation type field, a TWT information frame disabled field, a link ID bitmap present field, and an aligned TWT field.

FIG. 14D illustrates an example of a broadcast TWT parameter set field format that is a TWT parameter information field included in a TWT element format in case of a broadcast TWT according to an embodiment of the disclosure. The broadcast TWT parameter set field format may include a request type field, a target wake time field, a nominal minimum TWT wake duration field, a TWT wake interval mantissa field, a broadcast TWT information field (broadcast TWT info field), a restricted TWT traffic info field (restricted TWT traffic info field)(optional), and a coordinated TWT (C-TWT) information field (C-TWT info field).

FIG. 14E illustrates an example of fields included in the C-TWT information field of FIG. 14D according to an embodiment of the disclosure. The C-TWT information field (C-TWT info field) may include an average TWT SP duration field, a traffic information field (traffic info field), and a priority field.

The average TWT SP duration field may indicate an average time duration (i.e., TWT SP end time-TWT SP start time) of a corresponding TWT SP. The average TWT SP duration field indicates an expected TWT SP duration, and the expected TWT SP duration may be a value obtained by time-averaging the time duration from a TWT SP start time to a TWT SP end time. According to an embodiment, an OBSS AP having received the average TWT SP duration field may perform coordinated restricted TWT (C-R-TWT) by considering the field.

The traffic information field may indicate a feature (e.g., the presence or absence of SCS or the presence or absence of low latency) of traffic exchanged within a corresponding TWT SP.

The priority field represents the importance level of traffic in a corresponding TWT SP, and an OBSS AP refers to the field to more actively perform TXOP sharing with a TWT SP having a higher priority.

In particular, the NPCA-enabling time duration 1438 in FIG. 14A may include, for example, at least one of the following pieces of information:
Number of pieces of time information (# time info) 1450;
NPCA SP start time 1 1452;
NPCA SP duration 1 1454;
NPCA SP start time 2 1456;
NPCA SP duration 2 1458;
NPCA SP start time k 1460; and/or
NPCA SP duration k 1462.

The number of pieces of time information may correspond to the number of SPs indicated as NPCA-enabling time durations, the NPCA SP start time indicates the start time of each SP, and the NPCA SP start time may indicate an absolute time or may be indicated in the form of an offset based on a particular time. The NPCA SP duration indicates the length of the duration of each SP, and may be indicated in units of absolute time or in units such as TU. Alternatively, unlike FIG. 14A, if NPCA is periodically enabled, the NPCA-enabling time duration may be indicated by an SP period, an offset based on a particular start time, and the length of the SP duration. The NPCA-disabling time duration 1440 of FIG. 14A may also be indicated in the same manner as applied to the NPCA-enabling time duration 1438.

The contents of FIGS. 14A to 14E correspond to an example, and the contents of the disclosure are not limited by the contents described above.

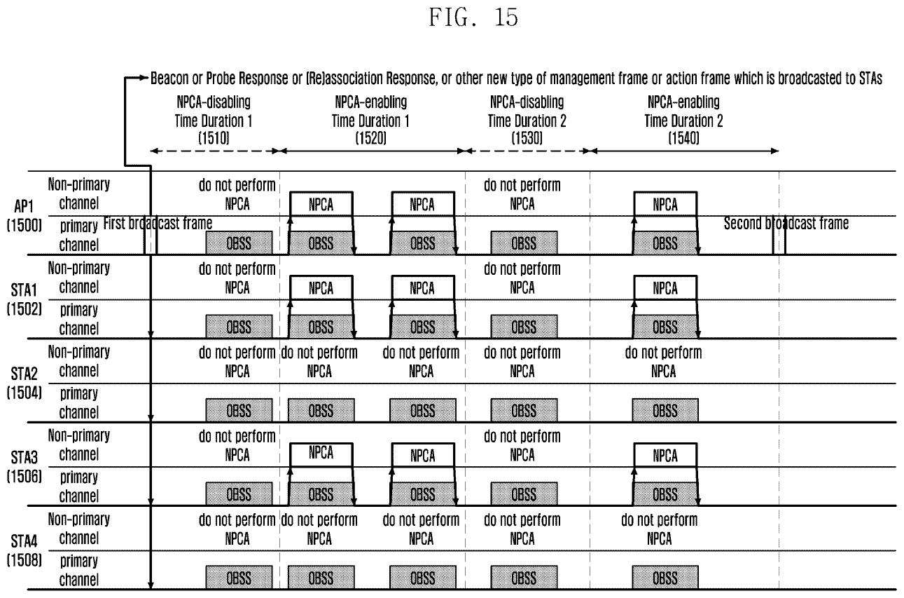

FIG. 15 illustrates an example in which NPCA based on an NPCA information element broadcast by an AP to an STA is performed according to an embodiment of the disclosure. According to FIG. 15, AP1 1500 may transmit a first broadcast frame to STAs. The first broadcast frame may be a beacon, a probe response, a (re) association response, or a new type of management frame or action frame broadcast to an STA. The first broadcast frame may include the information illustrated in FIG. 13 and FIGS. 14A to 14E, and may indicate that NPCA by STA1 1502 and STA3 1506 is enabled and NPCA by STA2 1504 and STA4 1508 are disabled. In addition, the first broadcast frame may indicate NPCA-disabling time duration 1 1510, NPCA-enabling time duration 1 1520, NPCA-disabling time duration 2 1530, and NPCA-enabling time duration 2 1540.

According to the indication of the first broadcast frame, STA1 1502 and STA3 1506 may perform NPCA if traffic of an OBSS exists on a primary channel in NPCA-enabling time duration 1 1520 and NPCA-enabling time duration 2 1540, which are NPCA-enabling time durations. Thereafter, AP1 1500 may transmit a second broadcast frame, the second broadcast frame also includes the information illustrated in FIG. 13 and FIGS. 14A to 14E, and STAs having received the second broadcast frame may perform NPCA according to updated NPCA-related configuration information.

FIG. 16 illustrates an example in which a list of NPCA parameter information is included in an NPCA information element according to an embodiment of the disclosure. According to FIG. 16, an NPCA information element may include a list of NPCA parameter information 1600. The list of NPCA parameter information 1600 may include the number of pieces of NPCA parameter information 1610, NPCA parameter information 1 1612, . . . , and NPCA parameter information k 1614. The number of pieces of NPCA parameter information 1610 may indicate the number of the pieces of NPC parameter information included in the list of NPCA parameter information 1600.

One piece of NPCA parameter information may include basic NPCA information 1620, NPCA-enabling condition information 1622, and time duration information 1624. The basic NPCA information 1620 may include, for example, at least one of information on an anchor channel (e.g., at least one of pieces of information such as a channel number and a bandwidth), information on an NPCH (e.g., at least one of pieces of information such as a channel number and a bandwidth), a modulation and coding scheme (MCS) and/or the number of spatial streams (NSS) available on the NPCH, and other NPCA-related information (e.g., MAC and PHY configuration information) necessary for performing NPCA. The NPCA-enabling condition information 1622 may be information indicating an STA capable of performing NPCA and a characteristic of traffic for which NPCA is enabled. For example, the NPCA-enabling condition information 1662 may include at least one of pieces of information, such as a list of AIDs capable of performing NPCA, a traffic identifier (TID) for which NPCA is performable, a stream classification service (SCS) ID for which NPCA is performable, an AC (typically in case of UL) for which NPCA is performable, a time duration during which NPCA is performable and/or a time duration during which NPCA is not transformable, and whether to avoid an OBSS TWT SP. The NPCA-enabling condition information may be information indicating an STA capable of performing NPCA and a characteristic of traffic for which NPCA is enabled.

The time duration information 1624 may be information indicating a time duration to which the basic NPCA information 1620 and the NPCA-enabling condition information 1622 are applied. The time duration information 1624 may indicate a particular time duration in the form of a start time and the length of the time duration (1630), indicate a particular time duration in the form of a start time and an end time (1632), or indicate a time duration to which the basic NPCA information 1620 and the NPCA-enabling condition information 1622 are applied, by using information (time resolution) indicating a particular time unit and a bitmap 1634. In case of reference numeral 1634, each bit corresponds to an indicated particular time unit, a bit value of 1 corresponds to a time duration to which the basic NPCA information 1620 and the NPCA-enabling condition information 1622 are applied, and a bit value of 0 may correspond to a time duration to which the basic NPCA information 1620 and the NPCA-enabling condition information 1622 are not applied. Alternatively, the opposite case is also possible. A time point at which the bitmap starts to be applied may be a particular reference time (e.g., TBTT).

For example, a time duration may be configured by dividing the time interval between a TBTT and the next TBTT that are beacon transmission times of an AP. When considering a beacon transmission period is generally 102.4 msec, if a list of NPCA parameter information has two elements and time duration information in respective NPCA parameter information [0,50] and [50,102.4], the first time duration is a time duration of 50 msec from a beacon transmission time, and the second time duration may indicate a time duration of after 50 msec from the beacon transmission time point up to 102.4 msec. Basic NPCA information and NPCA-enabling condition information in first NPCA parameter information are applied for 50 msec from the beacon transmission time, and basic NPCA information and NPCA-enabling condition information in second NPCA parameter information may be applied after 50 msec from the beacon transmission time point up to 102.4 msec. As described above, basic NPCA information and NPCA-enabling condition information applied for each time duration may vary. Therefore, a MAC/PHY parameter which may be included in the basic NPCA information or an NPCA performance condition according to the NPCA-enabling condition information may be configured to be different for each time duration. Accordingly, an AP may flexibly manage a STA performing NPCA.

The contents of FIG. 16 correspond to an example, and the contents of the disclosure are not limited by the contents described above. In addition, the contents of the disclosure are not limited by the names of fields described above.

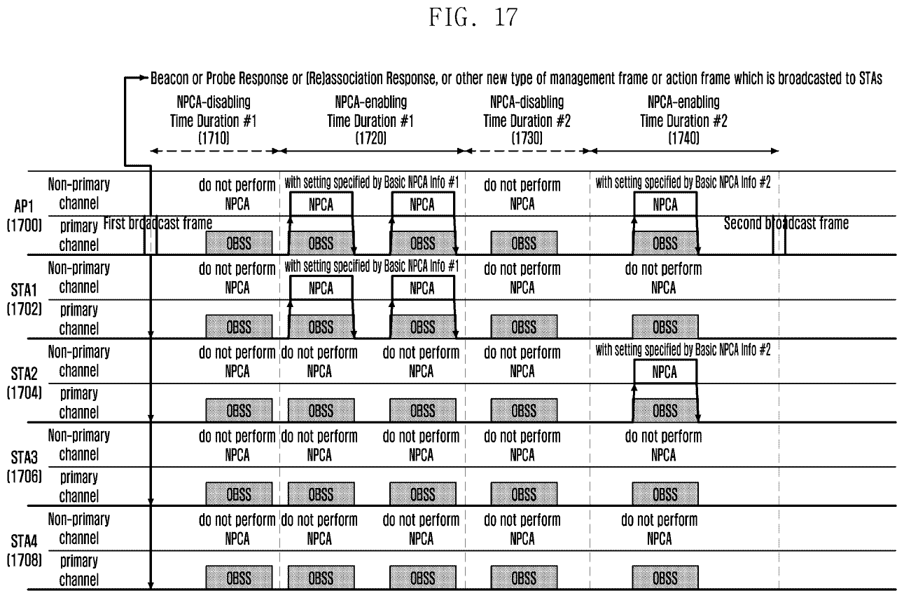

FIG. 17 illustrates another example in which NPCA based on an NPCA information element broadcast by an AP to an STA is performed according to an embodiment of the disclosure. According to FIG. 17, AP1 1700 may transmit a first broadcast frame to STAs. The first broadcast frame may be a beacon, a probe response, a (re) association response, or a new type of management frame or action frame broadcast to an STA. The first broadcast frame may include the information illustrated in FIG. 13, FIGS. 14A to 14E, and FIG. 16. In addition, the first broadcast frame may include information indicating NPCA-enabling time duration 1 1720 and an NPCA information element applied in NPCA-enabling time duration 1 1720, and include information indicating NPCA-enabling time duration 2 1740 and an NPCA information element applied in NPCA-enabling time duration 2 1740. In addition, the first broadcast frame may indicate NPCA-disabling time duration 1 1710 and NPCA-disabling time duration 2 1730. The NPCA information element applied in NPCA-enabling time duration 1 1720 and the NPCA information element applied in NPCA-enabling time duration 2 1740 may have different contents.

According to the indication of the first broadcast frame, STA1 1702 may perform NPCA in NPCA-enabling time duration 1 1720. This may be because only NPCA by STA1 1702 is allowed according to the indication of basic NPCA information 1 applied to NPCA-enabling time duration 1 1720. Thereafter, STA2 1704 may perform NPCA in NPCA-enabling time duration 2 1740. This may be because only NPCA by STA2 1704 is allowed according to the indication of basic NPCA information 2 applied to NPCA-enabling time duration 2 1740.

FIG. 18A illustrates an example of a configuration of an OBSS TWT element related to NPCA-enabling condition information according to an embodiment of the disclosure. An OBSS AP may transmit, to a neighboring AP, an OBSS TWT element that is TWT configuration information corresponding to the OBSS AP. The neighboring AP may configure, based on the TWT configuration information, at least one of NPCA-enabling time duration, NPCA-disabling time duration, or OBSS TWT SP information included in NPCA-enabling condition information, and broadcast, to STAs, an NPCA information element including the configured information.

According to FIG. 18A, an OBSS TWT element may include element identifier (ID) 1800, length 1802, control 1804, and OBSS TWT parameter information 1806. The OBSS TWT parameter information 1806 may include a broadcast TWT parameter set field 1810 and OBSS information 1812.

The broadcast TWT parameter set field 1810 may include at least one of the following pieces of information:
Request type.

The format of the request type field may include, as an example, a TWT request field, a TWT setup command field, a trigger field, a last broadcast TWT parameter set field, a flow type field, a broadcast TWT recommendation field, a TWT wake interval exponent field, and a reserved field.

The TWT request field has a value of 1 if a subject transmitting a corresponding TWT element is a TWT requesting STA or TWT scheduled STA (mainly STA), and has a value of 0 if the subject is a TWT responding STA or TWT scheduling AP (mainly AP).

The TWT setup command field indicates a type of a TWT command. The TWT setup command field is used for negotiation of individual TWT or broadcast TWT. The following uses are provided according to each value. Request TWT (value==0), Suggest TWT (value==1), Demand TWT (value==2), TWT Grouping (value==3), Accept TWT (value==4), Alternate TWT (value==5), Dictate TWT (value==6), Reject TWT (value==7).

The trigger field is an indicator indicating whether a trigger frame is transmitted in a TWT SP, and if the value of the field is 1, at least one trigger frame needs to be transmitted.

The last broadcast TWT parameter set field is an indicator indicating whether a corresponding broadcast TWT parameter is the last broadcast TWT parameter in a corresponding broadcast TWT element, and a broadcast TWT element having a last broadcast TWT parameter set value of 1 indicates that a corresponding broadcast TWT parameter is the last broadcast TWT parameter in the broadcast TWT element.

The flow type field indicates the type of interaction between a TWT requesting STA (or TWT scheduled STA) and a TWT responding STA (or TWT scheduling AP). If the value of the field is 0, this indicates announced TWT, and a TWT requesting STA (or TWT scheduled STA) needs to transmit a power save-poll (PS-Poll) or automatic power save delivery (APSD) trigger frame to notify that the TWT requesting STA is in an awake status, before a TWT responding STA (or TWT scheduling AP) transmits a frame which is not a trigger frame. If the value of the field is 1, this indicates unannounced TWT, and a TWT responding STA (or TWT scheduling AP) performs an operation of transmitting a frame without transmitting a PS-Poll or APSD trigger frame by a TWT requesting STA.

The broadcast TWT recommendation field is used to indicate a type of a frame transmittable by a TWT scheduled STA and a TWT scheduling AP during a broadcast TWT SP. For example, if the value of the broadcast TWT recommendation field is 0, there is no limitation on a frame transmitted in a broadcast TWT SP. If the value of the broadcast TWT recommendation field is 1, this indicates a recommendation to limit a frame transmitted in a broadcast TWT SP to a solicited status or solicited feedback (e.g., PS-Poll, QOS Null frames, feedback included in a QoS Control field or HE variant HT Control, feedback in an HE TB feedback NDP, a bandwidth query report (BQR), a buffer status report (BSR), a frame transmitted as a part of sounding feedback exchange, or a control response frame). Furthermore, a trigger frame transmitted by a TWT scheduling AP is unable to include a resource unit (RU) for random access.

If the value of the broadcast TWT recommendation field is 2, this indicates mostly the same as when the value is 1, but there is a difference in that a trigger frame transmitted by a TWT scheduling AP is required to include at least one RU for random access. If the value of the broadcast TWT recommendation field is 3, there is no restriction except that an AP transmits a TIM frame including a TIM element or a fast initial link setup (FILS) discovery frame earliest in each TWT SP.

The TWT wake interval exponent field is used to represent a TWT wake interval value. The TWT wake interval is an average time interval between two consecutive TWT SP start times. The value of the TWT wake interval exponent field indicates the exponent to base 2 when expressing a TWT wake interval value, which is in units of microseconds, as a base-2 number.

TWT wake interval=(TWT Wake Interval Mantissa)×2\hat{ }(TWT Wake Interval Exponent).
Target wake time: A target wake time field indicates a positive integer value corresponding to a time synchronization function (TSF) time for which an STA needs to be in a wake status.
Nominal minimum TWT wake duration: A nominal minimum TWT wake duration field indicates a time for which an STA needs to minimally remain in an awake status for frame exchange in a corresponding TWT SP, and the unit thereof is 256 us.
TWT wake interval mantissa: A TWT wake interval mantissa field indicates a mantissa value of a TWT wake interval, the unit of the TWT wake interval is microsecond, and a base value is 2.
Broadcast TWT information (broadcast TWT info).

FIG. 18B illustrates an example of the broadcast TWT information field according to an embodiment of the disclosure. Broadcast TWT information may include, for example, a restricted TWT traffic information present field (restricted TWT traffic info present field), a restricted TWT schedule information field (restricted TWT schedule info field), a broadcast TWT ID field, and a broadcast TWT persistence field.

The restricted TWT traffic information present field indicates the presence or absence of a restricted TWT traffic information field, and if the value of the field is 1, the restricted TWT traffic information field exists. This field value may be reserved for other uses for a non-EHT STA.

The restricted TWT schedule information field may be, for example, included when a restricted TWT parameter set field is transferred in a TWT element having a negotiation type field value of 2, and if the value of the field is 0, a corresponding R-TWT schedule indicates an “idle R-TWT schedule,” which indicates that there are no other member STAs or the schedule is suspended for all STAs. If the value of the restricted TWT schedule information field is 1, a corresponding R-TWT schedule indicates an active R-TWT schedule, which indicates that there is at least one member STA in the corresponding R-TWT schedule. If the value of the restricted TWT schedule information field is 2, a corresponding R-TWT schedule indicates a full R-TWT schedule, which indicates that the R-TWT schedule lacks resources or there are too many existing member STAs, making it difficult to admit a new STA as a member. If the value of the restricted TWT schedule information field is 3, a corresponding R-TWT schedule indicates that an advertised R-TWT schedule is activated, and the schedule is for an AP corresponding to a nontransmitted BSSID corresponding to a member of the same multiple BSSID set or co-hosted BSSID set transmitting the restricted TWT schedule information field.

The broadcast TWT ID field is used as an identifier indicating a particular broadcast TWT.

The broadcast TWT persistence field is a value expressing, by using the number of TBTTs, a time duration including a broadcast TWT SP corresponding to a corresponding broadcast TWT parameter set. For example, if the value of the field is 10, this indicates that a broadcast TWT SP configured by a corresponding parameter is operated for a time during which 10 beacons are transmitted, and if the value is 255, this indicates permanent application.
Restricted TWT traffic information (restricted TWT traffic info).

FIG. 18C illustrates an example of a restricted TWT traffic information field format included in a broadcast TWT information field format according to an embodiment of the disclosure. The restricted broadcast TWT information field may include a traffic information control field (traffic info control field), a restricted TWT DL TID bitmap field, and a restricted TWT UL TID bitmap field.

The restricted TWT DL TID bitmap field and the restricted TWT UL bitmap field represent, in the form of a bitmap, TIDs identified as latency sensitive traffic in downlink and uplink directions, respectively.

FIG. 18D illustrates an example of a format of a traffic information control field (traffic info control field) included in a restricted TWT traffic information field format according to an embodiment of the disclosure. The traffic information control field includes a DL TID bitmap valid field, a UL TID bitmap valid field, and a reserved field.

The DL TID bitmap valid field and the UL TID bitmap valid field indicate whether a restricted TWT DL TID bitmap field and a restricted TWT UL TID bitmap field are included, respectively. If the value of the field is 1, a restricted TWT DL TID bitmap field or a restricted TWT UL TID bitmap field are included in a restricted TWT traffic information field, and if the value of the field is 0, all TIDs are classified as latency sensitive traffic in corresponding R-TWT membership.

The OBSS information 1812 of FIG. 18A may include at least one of the following pieces of information:
A BSS identifier of an OBSS;
A MAC address of an OBSS AP;
A BSS color (a BSS identifier for identifying an OBSS assigned to each BSS); and/or
An expected operation duration for an OBSS TWT SP (the time between a start time point and an end time point of a TWT SP), and an indicator indicating whether NPCA is performed in the OBSS TWT SP (an indicator indicating whether to perform NPCA in the time duration).

If the indicator indicating whether NPCA is performed in the OBSS TWT SP is activated and thus NPCA is not performed in the OBSS TWT SP, this may be an operation for respecting the frame exchange within the OBSS TWT SP. Such an operation may be an example of a coordinated restricted-TWT (C-R-TWT) operation, which increases the success probability of frame exchanges within an R-TWT SP in each BSS through interaction between multiple APs (multiple BSSs). For instance, in case where a TWT SP of an AP operating in an OBSS is a restricted TWT SP (R-TWT SP), that is, in case where important traffic having a high priority and a high latency sensitivity is transmitted in the TWT SP, when an operation of emptying a channel is performed in the OBSS for a normal start of the R-TWT SP and a valid frame exchange before the start time point of the R-TWT SP, an NPCA operation may interrupt the frame exchange within the OBSS R-TWT SP, and thus NPCA is not performed in order to fundamentally prevent the interruption.

If T1 denotes a time obtained by converting, based on a TBTT of an AP's BSS (my BSS), a TWT start time in a broadcast TWT parameter set field within OBSS TWT parameter information, and Td denotes a value of an expected TWT SP duration in newly defined OBSS information, an NPCA-disabling time duration may be [T1, T1+Td] which is a time duration in which an OBSS TWT SP is expected to be operated. Since, in the time duration, an OBSS AP operates the TWT SP and thus a channel/bandwidth in which NPCA operates may be busy, the AP may decide not to perform NPCA in the time duration and may notify the AP's STA.

The contents of FIGS. 18A to 18D correspond to an example, and the contents of the disclosure are not limited by the contents described above. In addition, the contents of the disclosure are not limited by the names of fields described above.

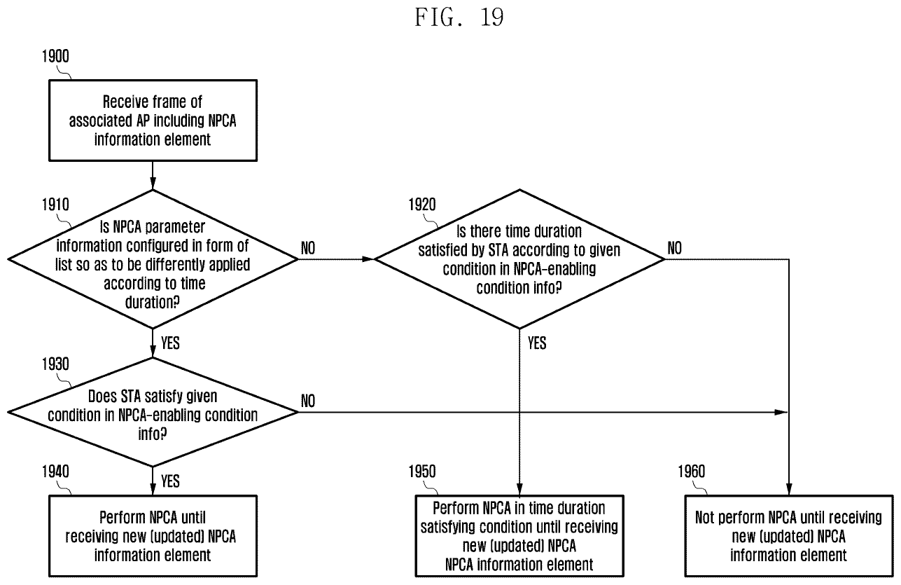

FIG. 19 illustrates an example of an operation of an STA performing an embodiment of the disclosure. An STA may be configured by an AP to selectively perform NPCA according to an embodiment of the disclosure. According to FIG. 19, an STA receives a frame including an NPCA information element from an associated AP (operation 1900). The frame may be a beacon, a probe response, a (re) association response, or a new type of management frame or action frame broadcast to the STA.

The STA determines, based on the received frame, whether the NPCA information element is configured in the form of a list so as to be differently applied according to a time duration (operation 1910). The meaning of the NPCA information element being differently applied according to a time duration indicates that, as in the example of FIG. 16, the NPCA information element is configured by multiple elements, and each NPCA parameter information object may be configured to have different basic NPCA information, NPCA-enabling condition information, and time duration information.

If the NPCA information element is not configured in the form of a list (i.e., the same NPCA configuration information is applied to NPCA-enabling time durations), the STA identifies whether there is a time duration satisfied by the STA according to a given condition, based on NPCA-enabling condition information (operation 1920). If the STA identifies that there is a time duration satisfied by the STA, the STA performs NPCA in the time duration satisfying the condition until receiving a new (updated) NPCA information element (operation 1950). If the STA identifies that there is no time duration satisfied by the STA, the STA does not perform NPCA until receiving a new (updated) NPCA information element (operation 1960).

If the NPCA information element is configured in the form of a list, the STA identifies whether the STA satisfies each NPCA-enabling condition information included in the list (operation 1930). If there is at least one time duration satisfied by the STA in each NPCA-enabling condition information included in the list, the STA performs NPCA in the time duration satisfying the condition until receiving a new (updated) NPCA information element (operation 1950). If the STA identifies that there is no time duration satisfied by the STA, the STA does not perform NPCA until receiving a new (updated) NPCA information element (operation 1960).

The above-described flowchart illustrates an exemplary method that may be implemented according to the principle of the disclosure, and various changes may be made to the method shown in the flowchart herein. For example, although shown as a series of operations, various operations in each drawing may overlap, occur in parallel, occur in a different order, or occur multiple times. In another example, an operation may be omitted or replaced with another operation. The values described above are merely an example, it is sufficiently possible to apply other values.

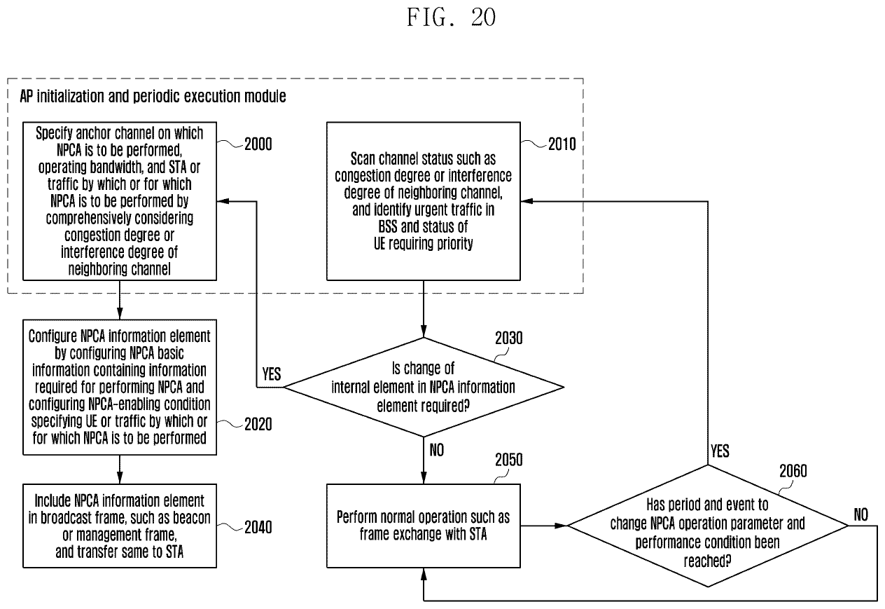

FIG. 20 illustrates an example of an operation of an AP performing an embodiment of the disclosure. According to FIG. 20, an AP determines at least one of an anchor channel on which NPCA is to be performed, a performance bandwidth, and an STA or traffic by which or for which NPCA is to be performed by considering a congestion degree or an interference degree of a neighboring channel (operation 2000). Thereafter, the AP obtains an NPCA information element (operation 2020). The NPCA information element may include basic NPCA information and NPCA-enabling condition information, and the above contents may be referenced for the detailed contents of an NPCA information element. The AP transmits, to an STA, a frame, such as a beacon or a management frame, including the obtained NPCA information element (operation 2040). The frames may be broadcast to STAs associated with the AP or transmitted (groupcast) to an STA group including one or more STAs. The STAs may operate according to the transmitted NPCA information element until receiving a changed NPCA information element.

Thereafter, the AP performs frame exchange with the STA(s) (operation 2050), and the frame exchange may include frame exchange through NPCA. The AP determines whether a period and/or an event to change an NPCA operation parameter and a performance condition has been reached (or is matched) (operation 2060). The period and event may vary depending on a subject that configures/manages the AP. The period may be configured to be as short as a beacon transmission period (or TBTT, or an integer multiple of the beacon transmission period) and be periodically configured to be as long as a unit of a day or a week. An example of the event may be detection of a new OBSS AP, removal of an OBSS AP, a change in the number of STAs within the coverage of the AP (or BSS), a change in the number of STAs associated with the AP (or BSS), or the inflow of traffic classified as urgent traffic (e.g., latency-sensitive traffic or traffic requiring low latency (low-latency traffic)).

If a period and/or an event to change an NPCA operation parameter and a performance condition has been reached (or is matched), the AP may identify a congestion degree or an interference degree of a neighboring channel and identify a status of the STA(s) such as whether there is urgent traffic required to be transmitted in a BSS or whether there is an STA requiring a high priority (operation 2010). Thereafter, the AP determines, based on identified information, whether a change of an internal element in the NPCA information element is required (operation 2030). If a change in the NPCA information element is required, the AP returns to operation 2000 and performs an operation for configuring an NPCA information element. If a change in the NPCA information element is not required, the AP performs frame exchange with the STA(s) (operation 2050), and the frame exchange may include frame exchange through NPCA.

The above-described flowchart illustrates an exemplary method that may be implemented according to the principle of the disclosure, and various changes may be made to the method shown in the flowchart herein. For example, although shown as a series of operations, various operations in each drawing may overlap, occur in parallel, occur in a different order, or occur multiple times. In another example, an operation may be omitted or replaced with another operation. The values described above are merely an example, it is sufficiently possible to apply other values.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate an AP and an STA.

In the drawings in which methods of the disclosure are described, the order of the description does not always correspond to the order in which steps are performed, and the order relationship between the steps may be changed or the steps may be performed in parallel. Alternatively, in the drawings in which methods of the disclosure are described, some elements may be omitted and only some elements may be included therein without departing from the essential spirit and scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an electronic device in a wireless local area network (WLAN), the method comprising:
obtaining a non-primary channel access (NPCA) information element;
transmitting a frame including the NPCA information element; and
performing an NPCA with a station (STA) associated with the electronic device on a non-primary channel (NPCH),
wherein the NPCA information element comprises basic NPCA information and NPCA-enabling condition information.

2. The method of claim 1, wherein the basic NPCA information comprises at least one of information on the NPCH, information on an anchor channel, information on at least one of a modulation and coding scheme (MCS) or a number of spatial streams (NSS) available on the NPCH, medium access control (MAC) configuration information related to the NPCA, or physical (PHY) configuration information, and
wherein the NPCA-enabling condition information comprises at least one of information on an STA capable of performing the NPCA, information on traffic for which the NPCA is performable, or information on a time duration during which the NPCA is performable.

3. The method of claim 2, wherein the information on the time duration during which the NPCA is performable comprises information on one or more time durations, and wherein each of the one or more time durations is indicated by a start time and a length of the duration.

4. The method of claim 1, further comprising receiving overlapping basic service set (OBSS) target wake time (TWT)-related information from an access point (AP) of an OBSS,
wherein the OBSS TWT-related information comprises information on a TWT service period (SP) of the OBSS, and
wherein the information on the TWT SP comprises at least one of information on a wake time, information on a wake duration, or information on an attribute of traffic in the TWT SP.

5. A method performed by an electronic device in a wireless local area network (WLAN), the method comprising:
receiving a frame including a non-primary channel access (NPCA) information element;
based on the NPCA information element, identifying whether an NPCA is performable; and
in case that the NPCA is performable, performing the NPCA on a non-primary channel (NPCH),
wherein the NPCA information element comprises basic NPCA information and NPCA-enabling condition information.

6. The method of claim 5, wherein the basic NPCA information comprises at least one of information on the NPCH, information on an anchor channel, information on at least one of a modulation and coding scheme (MCS) or a number of spatial streams (NSS) available on the NPCH, medium access control (MAC) configuration information related to the NPCA, or physical (PHY) configuration information, and
wherein the NPCA-enabling condition information comprises at least one of information on an STA capable of performing the NPCA, information on traffic for which the NPCA is performable, or information on a time duration during which the NPCA is performable.

7. The method of claim 6, wherein the information on the time duration during which the NPCA is performable comprises information on one or more time durations, and
wherein each of the one or more time durations is indicated by a start time and a length of the duration.

8. The method of claim 5, wherein the NPCA information element comprises information on one or more time durations, and the basic NPCA information and the NPCA-enabling condition information applied to each of the one or more time durations.

9. An electronic device in a wireless local area network (WLAN), the electronic device comprising:
at least one transceiver;
at least one processor communicatively coupled to the at least one transceiver; and
at least one memory, communicatively coupled to the at least one processor, storing instructions executable by the at least one processor individually or in any combination to cause the electronic device to:
obtain a non-primary channel access (NPCA) information element;
transmit a frame including the NPCA information element; and
perform an NPCA with a station (STA) associated with the electronic device on a non-primary channel (NPCH),
wherein the NPCA information element comprises basic NPCA information and NPCA-enabling condition information.

10. The electronic device of claim 9, wherein the basic NPCA information comprises at least one of information on the NPCH, information on an anchor channel, information on at least one of a modulation and coding scheme (MCS) or a number of spatial streams (NSS) available on the NPCH, medium access control (MAC) configuration information related to the NPCA, or physical (PHY) configuration information, and
wherein the NPCA-enabling condition information comprises at least one of information on an STA capable of performing the NPCA, information on traffic for which the NPCA is performable, or information on a time duration during which the NPCA is performable.

11. The electronic device of claim 10, wherein the information on the time duration during which the NPCA is performable comprises information on one or more time durations, and
wherein each of the one or more time durations is indicated by a start time and a length of the duration.

12. The electronic device of claim 9, wherein the instructions further cause the electronic device to receive overlapping basic service set (OBSS) target wake time (TWT)-related information from an access point (AP) of an OBSS,
wherein the OBSS TWT-related information comprises information on a TWT service period (SP) of the OBSS, and
wherein the information on the TWT SP comprises at least one of information on a wake time, information on a wake duration, or information on an attribute of traffic in the TWT SP.

13. An electronic device in a wireless local area network (WLAN), the electronic device comprising:
at least one transceiver;
at least one processor communicatively coupled to the at least one transceiver; and
at least one memory, communicatively coupled to the at least one processor, storing instructions executable by the at least one processor individually or in any combination to cause the electronic device to:
receive a frame including a non-primary channel access (NPCA) information element;
based on the NPCA information element, identify whether an NPCA is performable; and
in case that the NPCA is performable, perform the NPCA on a non-primary channel (NPCH),
wherein the NPCA information element comprises basic NPCA information and NPCA-enabling condition information.

14. The electronic device of claim 13, wherein the basic NPCA information comprises at least one of information on the NPCH, information on an anchor channel, information on at least one of a modulation and coding scheme (MCS) or a number of spatial streams (NSS) available on the NPCH, medium access control (MAC) configuration information related to the NPCA, or physical (PHY) configuration information,
wherein the NPCA-enabling condition information comprises at least one of information on an STA capable of performing the NPCA, information on traffic for which the NPCA is performable, and information on a time duration during which the NPCA is performable, and
wherein the NPCA information element comprises information on one or more time durations, and the basic NPCA information and the NPCA-enabling condition information applied to each of the time durations.

15. The electronic device of claim 13, wherein the information on a time duration during which the NPCA is performable comprises information on one or more time durations, and
wherein each of the one or more time durations is indicated by a start time and a length of the duration.
